(19) United States
(12) Patent Application Publication
(10) Pub. No.: US 2016/0152067 A1
(43) Pub. Date: Jun. 2, 2016

(54) Bucket With Ledges and Band Brush-Handle Holder

(71) Applicant: Jean Rittmann, Everett, WA (US)

(72) Inventor: Jean Rittmann, Everett, WA (US)

(21) Appl. No.: 14/557,728

(22) Filed: Dec. 2, 2014

(51) Int. Cl. B44D 3/12; B65D 21/02

(52) U.S. Cl. CPC B44D 3/121; B65D 21/0209; B44D 3/128

(57) ABSTRACT

A bucket with a substantially flat, laterally distally declining LHS ledge 7: top side for supporting a paint brush bristle end A3; and bottom side for use as an undercut handle, for a user to grab with fingers under ledge and thumb over LHS lip 1L. Single-wall construction allows multiple buckets to be stacked substantially one inside the other. LHS and RHS opposite-side inside ledges position high up so ledges can be utilized while majority volume of the bucket can contain paint. Bucket is RHS to LHS narrow enough that a brush can be angle-supported: handle on RHS lip 1R, bristle end on LHS ledge and against LHS upper portions AL. Brush lifted from supported position is easily drawn rightwardly to wipe on RHS wiping edge 8R. Wiping edge is inside bucket, to keep paint off bucket rim. Band E can secure paint brush or chip brush handles for transport.

### CROSS-REFERENCE TO RELATED APPLICATIONS

App. Ser. No. 11/286,975 PAINT BUCKET 2005 Nov. 28
App. Ser. No. 11/906,985, PAINT BUCKET WITH LEDGES, 2007 Oct. 5
App. Ser. No. 13/369,295 Bucket With Ledge as Brush Support and Bucket Holding Means Plus Opposite Side Wiping Edge and Elastic Brush Handle Holder 2012 Feb. 9

### STATEMENT REGARDING FED. SPONSORED RESEARCH OR DEVELOPMENT

Not Applicable

### REFERENCE TO A MICROFICHE APPENDIX

Not Applicable

### BACKGROUND OF INVENTION

This invention relates to receptacles with container attachment or adjunct. More specifically, to receptacles (paint buckets) including edge for removing excess material (i.e. scraper) with tool or brush holder.

Painting involves brush dipping, brush wiping, and brush holding. Also moving container of paint place to place while in use. Preferred is an easy-to-dip-into bucket, means to keep a paint implement out of the paint, but not dripping on floor. Can rim needs to be clean to seal a lid to a bucket. Container with smooth interior surfaces makes a container better for re-use, as paint dries in crevasses, and therein is not easy to remove for next color. Bucket sellers prefer to compactly stack buckets to reduce shipping costs and shelf space. Additionally pouring from and sealing a bucket would be benefits. It is a crowded art, yet prior art buckets have not yet fulfilled all these basic needs with a single bucket.

Round (at lip and base) buckets are common prior art. Round-lipped containers limit the dipping area of paint brushes, which have rectangular brush shape, and are substantially wide on flat side. This rectangular-brush—round-can problem is most obvious when one tries to dip a 4″ wide brush in a 1 gallon paint can. Prior Art FIG. 1 shows top view of 4″ brush A in a 1 gallon cylindrical paint can. The brush virtually has to be dipped straight down from the top of such a can. Inside diameter of a 1 gallon can rim IR averages a 5.5″, and exterior EC of can measures a diameter substantially 6⅝″. Can bottom covers a surface area of about 34 square inches (pi r squared). Relative large surface area of can bottom improves bucket stability. Though narrower brushes can be used, the 4″ width and average ⅞″ narrow-side thickness of 4″ wide brush A makes for a tight fit into the 5.5″ inside diameter of the cylindrical can rim. One flat side of the rectangular paint brush is marked FS. Bottom of a cylindrical can has a circumferential footing, or raised leg, for stability on when placed on a flat surface. Prior Art FIG. 3 is a 4″ brush on a 1 gal can, can front perspective view. The brush is laid flat side on top of the can. Wiping a flat-sided brush on a round rim leaves the brush with an uneven load of paint. Wiping brush nearly horizontal to more evenly wipe paint can leave paint in can rim sealing groove. Laying the brush on a can's rim drips paint out of the can, leaves the lip groove full of paint, gets the handle messy with paint, and is not always a secure place for the brush. Cleaning the intricate grooves for a good lid seal is difficult & time-consuming. Curved paint can handle is short and curved, such that picking up the can and dipping brush difficult. Holding a curved handle is uncomfortable.

U.S. Pat. No. 3,595,431 by Francis L. Bird, granted Jul. 27, 1971, entitled DRIPLESS PAINT CONTAINER shows a circular-lipped container. Redrawing of his FIG. 2 is my PRIOR ART FIG. 2, top view. 4″ brush A shown with bristles on rod and handle on rim. Rods, versus flat shelves, limit the size of brush they can hold. Note that a 4″ brush could not stay on his ledge, because the containers curved walls pushes it to the brush tip. Brushes have flex, and a heavy wet brush nearly requires like a full inch of support at the tip to not fall off. A 2″ wide brush would barely stay on his ledge with only about 0.5″ of support. If a rod placed in phantom line location, to support a 4″ brush, then 2″ wide brushes would easily slip into the paint container between the phantom rod and LHS inside of container. Using rods in a round container limits the SIZE of brush for which the rods may be used. Some bristles can split off below the rod, damaging the brush.

U.S. Pat. No. 4,927,046 by Robert E. Armstrong, granted May 23, 1990, entitled HOLDING VESSEL WITH SUPPORTIVE HANDLE has a ledge to hold brush bristles and has oppositely-positioned center spout notch to hold brush NECK. The pentagonal shape makes brush wiping on a lip difficult. I.E., a user cannot lift the brush from the support, then wipe it rightwardly, because that is where his FIG. 1 ¾ center spout/notch is. A user would drip paint out where that notch is if wiped straight across. The center spout notch reduces the likelihood that a lid could seal the vessel. Holding a container with his side handle 2 requires much effort to hold, as a hand more securely grasps objects with diameter large enough to employ grip of fingers-to-thumb. Due to his handle, his vessel cannot be stacked, one substantially inside the other. Armstrong teaches away from using the underside of the ledge as a handle or container holding means. It's virtually impossible to spread one's fingers like Spock (two on one side of the handle, two on the other) and grip under his shelf/ledge. Buckets are low ticket items, so large quantities must take up a minimal amount of space when shipped and shelved in stores. The entire underside of his ledge is not palpated, as the handle prevents such.

U.S. Pat. No. 6,105,816, by Donald L. Shea, 08-2000, entitled Painter's Aid is re-drawn in Prior Art FIGS. 10, 12, 13, and 14. Prior Art FIG. 10 is Shea's FIG. 15, minus notations, Prior Art FIG. 10 is Shea's FIG. 18, minus notations, Prior Art FIG. 13 is Shea's FIG. 13, minus notations, plus changing brush position if brush is to be wiped then placed on ledge. Prior Art FIG. 14 is Shea's FIG. 13, plus being grabbed by a user. When brush on shelf, Shea cannot pick up and hold his container with thumb on lip rim and fingers under brush supporting shelf because the shelf is top-to-bottom short, has no undercut/sloping angle to allow grip without slip, and shelf is so short that a user would get paint on their fingers from the wet brush. Shea does not disclose ANY method of holding his painter's aid, and there appears to be no way to hold it at all after there is paint or a paint brush on his platform. Prior Art FIG. 12 is Shea's FIG. 17, minus notations. Notched out raised lip means lid fits deeper down in his container, which makes it harder to remove. Shea didn't recognize non-neck-containment ways to stabilize a brush on top of a container. The farther down platform 22, the farther down in his wiping edge. Since wiping edge is AT lid seal, Shea's Aid top portions would need thorough wiping to clean for lid sealing.

Because a substantial portion of the weight of a wet brush is positioned distal to Shea's container bottom, the container can easily topple. More so because placing a brush down on the ledge places more force on the distal surface than just delicately balancing brush on shelf. Weight of brush is substantially on bristle/shelf side of the container, wherein the weight of paint placed in container is to the opposite side (See Shea's FIG. 18, showing container bottom, container top view). Brush length (handle end to bristle end) is fixed, and Shea grabs brush neck, therein Shea cannot create a more voluminous container, which could better overcome the imbalance of weight with a brush on top of container. Shea's size also limited by Shea claiming prior art can lid can be used as a lid. A taller tapered container would produce a tiny bottom, where wet brush on ledge could easily topple it.

Prior Art FIG. 13 shows that having a paint wiping ledge on SAME side requires rotating a brush 120 degrees, and leaving brush in awkward position in users hand. As positioned in figure, if wiping brush is made easy (wiping ledge on user's painting hand side) placing on ledge would be awkward, Turning Shea′ Aid around would make placing brush on ledge easy, but wiping brush awkward. Such hand awkwardness is shown in Prior Art FIGS. 15, 16, and 17, hand and wrist awkwardness using Shea's Painter's Aid. Upper drawing is paint brush wiped in Shea's aid, middle is a user painting surface, bottom drawing is placing brush on Shea's ledge. There is loss of control when one wipes a brush on a far-sided ledge. Example: when a right-handed user wipes a brush on a left sided ledge, wiping it upward-and-away tends to FLICK paint off the bristles!!! Meaning paint specks will be flicked outside the container and onto unwanted surfaces.

Prior Art FIG. 11 is Verhaar's FIG. 4 redrawn to include inside roller holder part. The semi-circular section inside his paint tray measures to take up half the dimension from point Z1 to point Z2. This can be verified by viewing Verhaar's FIG. 5. Verhaar's curved ledge between Z1 and Z2 is cylindrical, and of a shape that could mate with bottom half of a mini-roller. The center of a roller is rotationally fixed to a rigid handle. Therein, if roller placed in semi-circular section, handle crosses the tray to lay on tray pole side. Mini-roller positioning substantially horizontal. Roller is secured to lay on top by cupping roller. Semi-circular section cannot be used to pick up the tray with fingers under semi-circular section and thumb on rim, because paint-filled roller extends substantially 1″ above the tray lip. Rim cannot be made free of paint, because semi-circle extends to the top of tray. Semi-circular portion near Z1 cannot be continuous because paint could then not be able to drip back into tray. Grid inside edge Z3 is lower in tray than semi-circular ledge. Like most containers, his rim extends distally for lip rigidity/strength.

Paint brush handles vary in length girth, and shape. A rectangular paint brush, for painting a house, is defined by its width. Prior Art FIG. 4 shows 4″ wide brush A, flat side view. Brush width is the distance between brush RHS A1 and brush LHS A2. The flat side being substantially the stated 4″ in width. The brush has a length from brush bristle end A3 to brush handle end A4. An average 4″ wide rectangular paint brush is 11″ in length: 11″ brush tip to handle end. Brush handle is from brush neck A5 to A4 (top-most portion of handle end A6). A7 is the brush bristles. A8 is the brush ferrule, often a metal wrap securing brush bristles to handle base A9. A10 is a shoulder of the brush.

Prior Art FIG. 5 is brush A of FIG. 4, narrow side view. Bristles A7, ferrule A8, brush handle (A5 to A4), bristle end A3, and brush base A9 noted.

Chip brushes are narrower than rectangular paint brushes, and have much shorter handles. Chip brushes don't need long handles because their bristles are short and their narrow side is so thin that they can hold very little paint; therein chip brushes do not require the force of applying paint that rectangular brushes need, and therein do not require the leverage of a longer handle. Chip brush handles are made with unsmoothed wood.

Rectangular paint brushes and chip brushes are substantially rigid, in that they can be supported much as if they are a plank. Brush handle is rigid; ferrule rigid. Brush bristles are dense, and brush narrow side is fairly substantial, such that, the weight of the brush, even wet with paint, is not substantially heavy enough that bristles would bend when brush is supported just at bristle end and handle end.

Prior Art FIG. 6 is brush A set on supporting surface S, narrow side view. Restraining brush A from toppling frontward or backward could be done by confining brush at both point R1 and R2. This is the brush-supporting means used by U.S. Pat. D527,153 S, dated Aug. 22, 2006, by Morad, Fred I. and Camp, Jr.; William P. entitled Bucket. Also the brush supporting means of U.S. Pat. No. 5,341,969, Aug. 30, 1994 by Accardo et al, entitled Container Accommodating paint Roller and Brush and Lid Therefor. As well as the supporting means of U.S. Pat. No. 5,810,196 by Michael J. Lundy, granted Sep. 22, 1998, entitled PAINT BUCKET, and U.S. Pat. No. 4,164,299 by Patti S. Fuhr, granted Aug. 14, 1979, entitled TRAY FOR PAINT AND BRUSHES. As well as the supporting means of Sur-line pail #12300, a 5 qt. bucket. All show a separate compartment to stand a brush upright while not in use/a separate compartment to hold a brush. Supporting a brush upright supports it on bristle ends, which are the most flexible and damageable part of a brush. Bristles are individually delicate, especially at their tips. Bristles are preferred unbent at their tips. A brush set upright in such a manner, for extended time, eventually bends the tips of the bristles, making a paint brush near useless for smooth painting. Also, a user must lift the brush into a vertical position to put it in the brush compartment. The non-brush support compartment side of the paint pail is easiest to use when closest to the user, so a user must reach over and vertically place the brush in with every stopped use. A side note: such brush compartments have detailed surfaces that are hard to clean paint off of.

Shur-line's pail has roller grid wall that tapers up one side of the bucket. Verhaar's Paint Tray for a Mini-Roller also tapers up one side of the container. (Pat. No. D518,263 by John Thomas Verhaar, granted Mar. 28, 2006) On both Shur-line's and Verhaar's, the level of paint in bucket must be substantially 6.28″ below the uppermost portion of the grid taper, or else a roller cannot be rolled up and down grid evenly and out of the paint volume. Roller diameter of 2″->2 pi r circumference=6.28 inches. 6.28″ is a substantial distance into a bucket. Pressure must be placed on the grid side of the pail when rolling a roller on it. Less than 6.28 means lifting roller, and rolling, which leaves uneven paint on a roller. A bucket with such a grid/tapered side would easily tip when rolling a roller up and down grid without holding pail, so one substantially needs to use a second hand to secure the pail. Or in Verhaar's Tray, a pole support is required.

Sur-line's pail has a hole where the roller handle can sit to keep roller out of paint so roller won't soak therein drip. For the roller to be hung inside the pail but not in the paint, the pail must be about ⅔ empty. Because the bucket is tall and deep, a brush painters hand is more likely to get paint on it, especially if roller and brush used alternately. Less than ⅓ of the volume of Verhaar's tray, that can contain liquid, can contain liquid below the lowest ledge edge Z3.

Another means of supporting a brush is horizontally, substantially by fulcrums. PRIOR ART FIG. 7 shows brush supported on flat side, narrow side view. Brush A is re-drawn from PRIOR ART FIG. 5, but placed horizontally. Such a horizontally placed brush could be stably supported at distant fulcrums (points) F1 and F2. This is the prior art support method of placing a paint brush the diameter of a 1 gallon paint can's rim, as shown in Prior Art FIG. 3. It is also substantially the support utility of Shea (Prior Art FIG. 10). 4″ wide (2″ diameter) rollers have handles 10″ to 11.5″ from roller barrel to handle tip. Prior art 9″ (2″ dia.) rollers have handles 12″ to much longer extended handles from roller barrel to handle tip.

Prior Art FIG. 8 shows angularly supported brush, narrow side view. A brush is supported by support points F3, F4, and F5. Support F3 stops brush from sliding leftward. This is the support means of Shea and Armstrong. Additionally, Shea and Armstrong provide side restraint, in the form of a notched-out lip. Such side restraint is represented as F6. Though there is no exact area of brush neck, brush neck is substantially the lower half of the distance between brush shoulder A10 and brush handle end.

Prior Art FIG. 9 shows angularly supported brush A of Prior Art FIG. 8, container top view. This is substantially the support utility of Armstrong, where the brush is supported, bristles inside the container, handle out. F3 is the container portion above the brush bristles, F4 is the brush supporting ledge, F6 and F7 are the sides of the notched-out rim section, and F5 is the bottom of the notched out rim, ie the support that holds the handle up. Shea also uses a notched out rim section to secure the handle of a brush in a completely horizontal position.

U.S. Pat. No. 5,199,571, entitled NESTABLE BUCKETS HAVING LOCKABLE BAILS, by Stacy L. Wolff, Charles W. Craft Jr., dated Apr. 6, 1993, discloses (Abstract), “when the bucket (10) is stacked with like buckets . . . the handles . . . of the lowermost three buckets . . . are underneath a spout . . . of the lowermost bucket”. Bucket and basket-type injection molded parts often have all walls with a 5 degree taper, wherein the opening of the bucket is larger than the base. This can allow for buckets to be closely stacked together, so long as the taper is continuous through all vertical walls.

Prior Art FIG. 18 is a vine band, front side view. Plantra Stretchlock Rubber Vine ties, and T-band ties are elastic bands with a bulbous arrow-shaped base (Prior Art FIG. 18, notation E). These bands are often used to secure grape vines to upright posts by stretching the closed band's loop portion EE circumferentially around the 2 poles, then opening the loop, and wrapping the loop arrow head end inside it. Prior Art FIG. 19 is vine band of P.A. FIG. 18 securing 2 poles.

Prior Art bucket/can handles are confined to the bucket at front and back midpoints of the bucket/can. Handle ends are rotationally free, and handles are of a size and shape such that the handle can lay against RHS portions of the bucket/can. Handle can be rotated counter clockwise outside the bucket/can rim, and then be laid against LHS portions of the bucket/can. That is, handle is shaped slightly larger than the RHS or LHS rim profile of the bucket/can.

Rectangular-lipped food containers with rounded corners allow for a secure seal to a lid. Other prior art brush holding means include magnets, where the brush needs positioned just so and the bucket is to be held to pull the brush off to not spill paint. Also, paint can get on the ferrule, which reduces magnet effectiveness.

So far, examiners have presented 64 patents against Application. Buckets/paint trays is a crowded art. In tables below of cited prior art, “O” means yes, “X” means no, and “?” means patent may not claim, but design is such that it may be possible to use a component for the utility.

| | | | | | | | | | incline |
|---|---|---|---|---|---|---|---|---|---|
| | | shelf | close- | shelf | shelf | | edge | elastic | shelf w/ |
| Prev. cited | brush | fixed | stack- | flat/ | as | wipe | oppst. | handle | across |
| U.S. Pat # | shelf | w/bkt | able | horiz. | handle | edge | shelf | holder | brush |
| 482,082 | O | O | X | X | X | O | O | X | X |
| 1,111,159 | O | X | X | O | X | O | X | X | X |
| 1,764,763 | O | X | X | O | X | O | X | X | X |
| 1,994,525 | O | O | X | X | X | O | X | X | X |
| 2,259,927 | O | X | X | X | X | O | X | X | X |
| 2,487,990 | O | X | X | X | X | O | O | X | X |
| 2,639,835 | O | X | X | X | X | O | X | X | X |
| 2,705,334 | O | X | X | X | X | O | X | X | X |
| 2,748,977 | O | X | X | X | X | O | X | X | X |
| 3,395,828 | O | X | X | X | X | O | X | X | X |
| 3,595,431 | O | O | X | X | X | O | O | X | X |
| 3,829,926 | X | — | — | — | — | X | X | X | X |
| 4,061,242 | X | — | — | — | — | O | X | X | X |
| 4,164,299 | O | O | X | X | X | ?O | X | X | X |
| 4,203,537 | O | X | X | O | X** | O | O | X | X |
| 4,491,234 | O | O | X | X | X | ?O | X | X | X |
| 4,756,046 | X | — | — | — | — | ?O | X | X | X |
| 4,927,046 | O | O | X | O | X | ?O | X | X | O |
| 5,199,571 | X | — | — | — | — | X | X | X | X |
| 5,207,348 | O | X | X | X | X | O | X | X | X |
| 5,261,577 | O | X | X | X | X | ?O | X | X | X |
| 5,297,695 | O | X | X | X | X | O | X | X | X |
| 5,322,183 | O | X | X | X | X | ? | X | X | X |
| 5,341,969 | O | O | X | X | X | ?O | X | X | X |
| D350,632 | O | O | X | X | X | ? | ? | X | X |
| 5,509,169 | O | O | O | X | X | X | X | X | X |
| 5,546,628 | O | O | X | X | X | ?O | X | X | X |
| 5,549,216 | O | X | X | X | X | ?O | X | X | X |
| 5,641,087 | X | — | — | — | — | ?O | X | X | X |
| 5,687,873 | O | X | X | X | X | ?O | X | X | X |
| 5,683,009 | O | X | X | X | X | X | X | X | X |
| D389,626 | O | O | ? | X | X | O | X | X | X |
| 5,727,708 | X | — | — | — | — | O | X | X | X |
| 5,746,345 | O | O | O | X | X | ?O | X | X | X |
| 5,810,196 | O | O | ? | X | X | X | X | X | X |
| RE35,933* | O | X | X | X | X | | | X | X |
| 6,062,389 | X | — | — | — | — | ? | X | X | X |
| 6,065,633 | O | O | O | X | — | O | X | X | X |
| 6,105,813* | O | O | O | X | — | O | X | X | X |
| 6,098,805 | X | — | — | — | — | ? | X | X | X |
| 6,105,816 | O | O | O | O | X | O | X | X | X |
| 6,138,963 | O | O | X | X | X | O | X | X | X |
| D457,995 | ? | — | — | — | X | **O | X | X | X |
| A0096527 | O | O | O | ? | X | ** | | X | X |
| 6,446,829 | O | X | X | X | X | O | X | X | X |
| 6,493,901 | O | X | X | O | X | ?O | X | X | X |
| D470,634 | ? | O | X | X | X | O | ?O | X | X |
| D476,787 | O | X | X | O | X | ?O | X | X | X |
| D477,447 | O | O | ? | X | X | ?O | X | X | X |
| A0121925 | O | O | O | X | X | | | X | X |
| D481,502 | ? | O | O | X | X | O | X | X | X |
| D483,917 | O | O | X | X | X | O | X | X | X |
| A0206761 | O | X | X | X | X | O | XO | X | X |
| A0161460 | X | — | — | — | X | X | X | X | X |
| D518,263 | O | O | X | X | X | ?X | ? | X | X |
| 0081637 | O | O | O | X | X | O | X | X | X |
| D522,241 | X | — | — | — | X | X | — | X | X |
| D527,153 | O | O | X | X | X | X | — | X | X |
| 0219720 | O | O | O | X | X | O | X | X | X |
| 0226156 | O | X | X | X | X | O | X | X | X |
| D537,996 | O | O | O | X | X | ?O | X | X | X |
| 7,410,074 | X | — | — | — | X | O | ?X | X | X |
| 7,467,728 | O | O | O | X | X | O | X | X | X |
| 7,784,145 | X | — | — | — | X | ? | X | X | X |

### BRIEF SUMMARY OF THE INVENTION

A bucket with a substantially flat, angling upwardly LHS ledge, topside for supporting a paint brush bristle end and bottom side for use as an undercut handle, for a user to grab with fingers under ledge and thumb over LHS lip. Simple continuous shape allows multiple buckets to be stacked substantially one inside the other. LHS and RHS opposite-side inside ledges position high up so ledges can be utilized while a majority volume of the bucket can contain paint. Bucket lip, RHS to LHS, is short enough that a brush can be angle-supported: handle on RHS lip, bristle end on LHS ledge and against LHS upper portions. When brush is lifted from supported position, it is easily drawn rightwardly to wipe on RHS wiping edge. Wiping edge is inside bucket, so paint doesn't get on bucket rim. Band can secure brush handle for transport.

### Advantages of the Invention

The LHS ledge has multiple utilities: supporting brush bristles when brush placed across bucket, and allowing a user to pick up the bucket by grabbing under ledge and over LHS lip, all while brush is still in place on the ledge. The simple design (plus 5 degree side taper) allows buckets to be stacked one inside the other. The RHS ledge lets a painter wipe a brush slightly down and away from the lip, to keep the brush handle clean, and the bucket lip clean for sealing to a lid. RHS ledge is wide enough to wipe even a 4″ wide brush without paying much attention to exact positioning. RHS ledge slopes into bucket to allow paint to drip back in the bucket. One can pour paint from that side's corners.

LHS ledge is wide and front-to-back deep enough to easily support 4″ wide brushes. It is down about 30% downward into bucket (perhaps 1.75″ to 2″) to angularly lay a brush bristles on the LHS ledge without dripping paint outside the bucket (with brush handle laid on RHS lip rim.) LHS ledge is at an angle to mate with a supported brush bristles, where wet paint on bristles helps adhere bristles to LHS ledge, which helps keep the brush from slipping off. A user can hold the bucket by gripping underside of LHS ledge and LHS rim together; user can hold bucket even with brush supported, and user still not get paint on their hand.

The front-to-back depth of the bucket is not substantially more than 1.5 times brush width, therein containing the brush on the LHS ledge, even when bucket is shifted, by brush shoulder bumping/horizontally supporting against bucket front or back side. There is no set depth, as what is critical is a substantial portion of brush bristle end stays on LHS ledge & handle end stays on bucket lip. No notched out rim section is needed (like in prior art) to secure brush position laying in bucket.

The buckets rectangular shaped lip and body easily allows a wide (like 4″) brush to be dipped into a left-to-right, and front-to-back large area. Wider bucket means taller metal handle, which allows easier dipping while holding the bucket's handle. The bucket can also be tilted (to get the last of the paint) by grabbing under the LHS ledge and above the LHS lip, like a handle. An average bucket can hold a gallon of paint while still utilizing the lowest ledge. Ledges formed as upside-down L-shaped indentations in a bucket are as easy to injection mold as most prior art plastic buckets, easy to clean, and buckets can therefore compactly be stacked, reducing shipping costs and shelf space. Because there are no extra parts (like metal rods), a paint manufacturer could sell their paint in the bucket. The RHS & LHS ledges average 6.25″ wide, so one doesn't have to maneuver a 4″ brush to support or wipe it, like if the ledge were only the exact width of the brush.

Bucket handle is taller and flatter at the top than prior art cylindrical buckets. A longer handle makes the buckets dipping area larger. Holding the flat handle is easier. A 4″ painting grid can fit in my bucket because of the square lip and straight close-to-the-top RHS wiping edge. The bucket lip's rectangular shape is best for mini-rollers, which average 4″ wide. The bucket is as easy to use by both left-handed and right-handed users (just turn the bucket around). Laying a brush down on/in the bucket is a more convenient position to leave a brush, as it requires no wrist twisting like second-compartment brush supports. Tip of brush stays undamaged, versus brush storage in upright position (Prior Art FIG. 6). Inserting a separate roller grid, versus making the grid part of the bucket, allows for stable weight balance in the bucket and allows for more paint to be filled in the bucket. Laying a brush from RHS lip to LHS ledge is most advantageous because RHS wiping edge is inside bucket, keeping RHS lip clean. That is, RHS wiping edge and LHS ledge work together: keeping paint off a brush handle and bucket lip. A brush is comfortably grabbed in the area between handle end and neck, making grabbing brush from ledge easy. The confining front and back sides keep a brush placed on the LHS ledge from sliding off when bucket is jostled around.

Nestable buckets having lockable bails, by Wolff et al, patented Apr. 6, 1993, shows in his FIG. 2, the top of the lip dips down at both pour spouts (notations 18 and 19). Horizontal edge surface 22 is identified in Wolff's FIG. 1.

### BRIEF DESCRIPTION OF THE DRAWINGS

Prior Art FIG. 1 top view of 4″ brush in cylindrical paint can.

Prior Art FIG. 2 is Bird's bucket in use as a ledge, top view.

Prior Art FIG. 3 is a 4″ brush on a 1 gal can, front perspective view.

Prior Art FIG. 4 shows a 4″ wide brush, flat side view

Prior Art FIG. 5 is the brush of FIG. 4, narrow side view.

Prior Art FIG. 6 is brush A, supported upright, narrow side view.

Prior Art FIG. 7 shows brush supported on flat side, narrow side view.

Prior Art FIG. 8 shows angularly supported brush, narrow side view.

Prior Art FIG. 9 shows angularly supported brush, top view.

Prior Art FIG. 10 is Shea's FIG. 15, minus notations

Prior Art FIG. 11 is Verhaar's FIG. 4 redrawn to include inside curve

Prior Art FIG. 12 is Shea's FIG. 17, minus notations

Prior Art FIG. 13 is Shea's FIG. 13, plus changing brush position

Prior Art FIG. 14 is Shea's FIG. 13, plus being grabbed by a user

Prior Art FIG. 15 hand and wrist awkwardness using Shea's Painter's Aid.

Prior Art FIG. 16 hand and wrist awkwardness using Shea's Painter's Aid.

Prior Art FIG. 17 hand and wrist awkwardness using Shea's Painter's Aid.

Prior Art FIG. 18 a vine band, front side view

Prior Art FIG. 19 is vine band of P.A. FIG. 18 securing 2 poles

FIG. 1 is the embodiment gripped & with brush, front view.

FIG. 2 prior art brush angle-laid, brush narrow side view.

FIG. 3 shows two buckets stacked one inside another, front view.

FIG. 4 is the embodiment, user gripping ledge & handle, front view.

FIG. 5 is the embodiment with a prior art brush, top view.

FIG. 6 embod. w/brush A cocked on LHS ledge 7, bucket top view.

FIG. 7 is the embodiment, user dipping brush & hung, front view.

FIG. 8 is the embodiment, top view.

FIG. 9 is the embodiment, bottom view.

FIG. 10 is the embodiment, RHS view.

FIG. 11 is the embodiment, LHS view.

FIG. 12 is a view indicating cross sections

FIG. 13 is a bucket cross section

FIG. 14 is a cross section detail of FIG. 12

FIG. 15 is a bucket cross section

FIG. 16 is the bucket, front perspective view

FIG. 17 is a bucket cross section

FIG. 18 is a bucket cross section

FIG. 19 is a bucket cross section detail of FIG. 18 plus P.A. lid

FIG. 20 is the embodiment, top view.

FIG. 21 is a cross-section, front view.

FIG. 22 is a cross-section, front view.

FIG. 23 shows a roller on embodiment, front view

FIG. 24 shows a roller grid in embodiment, front view

FIG. 25 is the embodiment with a prior art roller grid, top view.

FIG. 26 is a detail of the embodiment holding chip brush, front view.

FIG. 27 shows brush support of LHS ledge

FIG. 28 shows example of non-supporting ledge

FIG. 29, shows demonstration of a non-functionable LHS ledge

BRIEF DESCRIPTION OF THE NOTATIONS

| | |
|---|---|
| EC exterior of can | F1 a support point |
| IR inside rim | F2 a support point |
| A a prior art rectangular paint brush | F3 a support point |
| A1 a brush RHS | F4 a support point |
| A2 a brush LHS | F5 a support point |
| A3 a brush bristle end | F6 a side restraint |
| A4 top-most portion of handle end | F7 a side restraint |
| A5 a brush neck | R1 a support point |
| A6 handle end | W horizontal plane |
| A7 brush bristles | R2 a support point |
| A8 a brush ferrule | S a supporting surface |
| A9 a prior art brush handle base | S2 a horizontal surface |
| 1 lip top edge | Ø an angle from horizontal |
| 1F front lip side | ØL an angle line |
| 1B back lip side | 10R RHS rim portion |
| 1FM front top portion middle | 10L LHS rim portion |
| 1BM back top portion middle | 10F front side rim portion |
| 1R RHS lip side | 10B back side rim portion |
| 1L LHS lip side | 11F front handle support |
| 2 vertical cross-section | 11B back handle support |
| 3 a ledge edge | 12 handle |
| 4 prior art grid | 13 a front-to-back depth |
| 5F front side portions | Z1 a point |
| 5B back side portions | Z2 a point |
| 6R RHS portions | Z3 a point |
| 6L LHS portions | T a top portion |
| 7 LHS ledge | P paint containment section |
| 7A top side of LHS ledge | EE loop portion |
| 7B bottom side of LHS ledge | E elastic band |
| XX a location | V vertical direction |
| 8 RHS ledge | Y a bucket |
| 8R wiping edge | Y2 a bucket formed like bucket Y |
| 9 bottom | H a hole |
| 9A bottom of containment | BE bulbous end |
| 9B circumferential bottom leg | AL above-ledge portion |
| 10 bucket rim | AOI angle-of-incline |
| F8 a support point | X1 a cross-section |
| F9 a support point | X2 a cross-section |
| FX a side restraint | X3 a cross-section |
| Q1 outer area of shelf width | Z a rim cross section area |
| Q2 outer area of shelf width | Y1 a cross-section |
| Q3 outer area of wipe width | Y2 a cross-section |
| Q4 outer area of wipe width | Y3 a cross-section |
| Q a prior art style lid | 1M lip |
| W a rim cross section area | XXX a location |

### DETAILED DESCRIPTION OF THE INVENTION

### 1. Bucket With Ledges

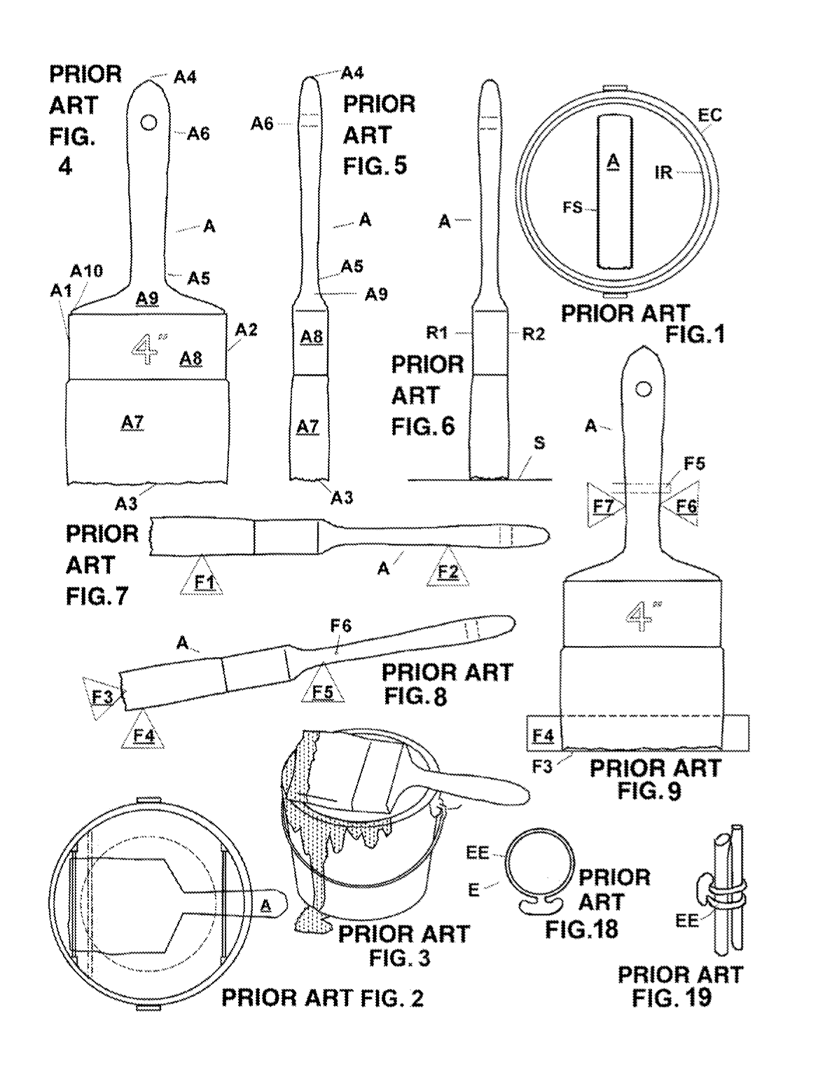

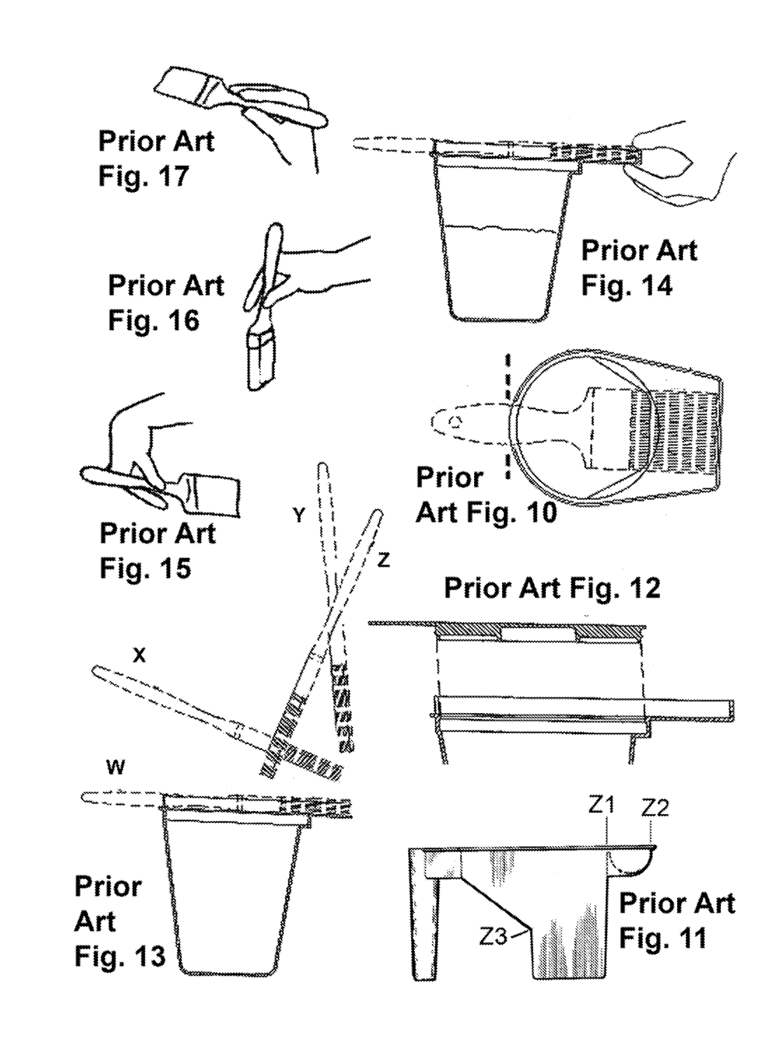

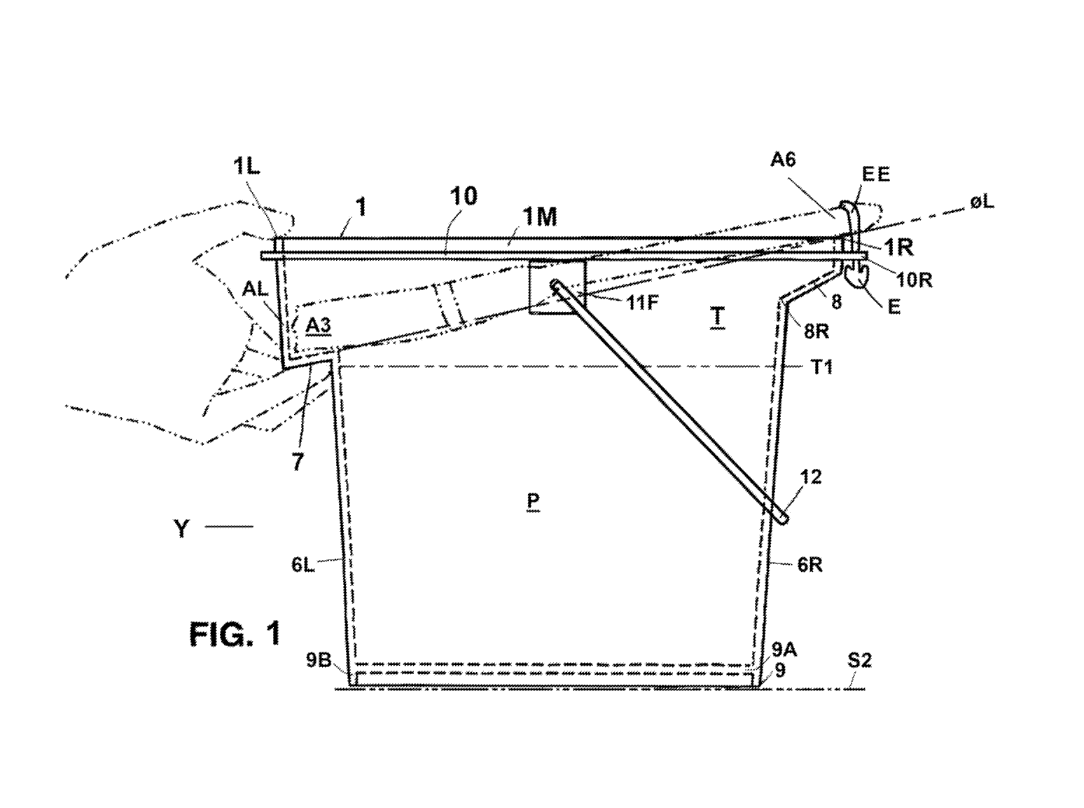

FIG. 1 is the embodiment gripped & with brush, front view. FIG. 1 shows an injection-moldable bucket Y. Said bucket of a size and shape to contain paint (substantially in paint containment section P. Said bucket having a top portion T. Said top portion being substantially the top 30% of height of said bucket, which is substantially from T1 to lip edge 1. That is, if a bucket was 7″ tall (from 1 to bottom 9), then top portion would be from top of lip 1 to 2.1″ down. “Substantially” meaning measure is not exact, but approximate. LHS ledge 7 is substantially in said top portion. If the ledge were instead to be positioned substantially lower in the bucket: #1. Less volume to contain paint below LHS ledge; #2. The more difficult it would be for a user to support bucket with fingers under LHS ledge and thumb over LHS rim. That is because a user's hand is strongest with hand in a cupped fingers-to-thumb grab. Compare cupped-hand hold to impossible hold of pinching position shown in Prior Art FIG. 14. Likewise, cupped-hand hold stronger than if fingers were more straightened, as the thumb would secure less force: Much force is needed to hold down bucket at lip, as the center weight of the bucket is not directly above the user's fingers, but substantially to the right. Having one bucket stack inside another requires about a 5 degree wall taper. With such taper, paint containment section P, in an embodiment for a 4″ brush, could contain substantially 12 cups of liquid, wherein the top 30% height of the bucket could contain about an additional 7 cups. So the majority of the bucket's volume for paint/fluid containment (inside said bucket below said lip) is below said LHS ledge.

Said bucket having a circumferential rim 10. Said rim extending circumferentially about said bucket. Said rim extending substantially horizontally/distally from said top portion. [In this embodiment, the rim is at the base of lip 1M] Said bucket (in FIG. 1) having a lip edge 1; said lip edge being the top surface of said bucket. Said bucket substantially having [notated in FIG. 11: front side portions 5F, back side portions 5B], RHS portions 6R, and LHS portions 6L. All 5F, 5B, 6R, and 6L portions together integrally forming the walls of said bucket/container. All said walls, along with bucket bottom 9, integrally form a container for having volume for containing liquid or paint. Said bucket having volume for containing liquid; Bottom 9 includes 9A (bottom of containment) and 9B (circumferential bottom leg).

Said lip having a RHS lip side. Said LHS portions having a LHS ledge 7, said LHS ledge integrally formed from lower-most parts (near T1) of said top portions T of said LHS side portions. That is, down about 30% of the bucket height, LHS ledge is substantially an indentation in said LHS portion 6L. Because said front side and said back side portions are integrally formed, their shape is altered to accommodate the LHS ledge indentation, so the bucket remains a continuous container for containing paint. Said bucket having a substantially horizontal bottom 9. Said LHS portions including a LHS above-ledge portion AL. Said LHS above-ledge portion extending above said LHS ledge 7. Said bucket having a LHS-to-RHS supporting width. Said supporting width substantially being from said LHS above-ledge portion AL substantially at (i.e. near where it abuts said LHS ledge 7) to said RHS lip edge side 1R. Said supporting width being of a width to support a rectangular paint brush at an angle. Said supporting width being less than the length (from A4 to A3) of the brush. Said supporting width being greater than the length from the brush tip to brush neck.

Said bucket having a horizontal bottom 9. Bucket bottom is both for containing paint and for placing on a horizontal surface, like horizontal surface S2. Said angle being substantially the angle-from-horizontal of the supported brush: brush bristle end A3 supported flat side on said LHS ledge 7, brush bristle end A3 abutting against said LHS above-ledge portion AL, and brush handle end A6 supported upwardly on said RHS top of lip side 1R. That is, said LHS ledge is not parallel to bucket bottom, but at an inclining medially (from-LHS-to-RHS-into-said-bucket) angle. Said LHS ledge having a shelf width. Said shelf width (in FIG. 11, that shelf width is Q1 to Q2) substantially at least as wide as width of the rectangular paint brush. (i.e., if bucket is for a 4″ brush, shelf width being at least 4″ wide from Q1 to Q2). Q1 is bucket back side outer area of shelf width. Shelf being a substantial portion of ledge 7. Q2 is bucket front side outer area of shelf width. Brush bristles are substantially 15 degrees lower in said bucket than the brush handle.

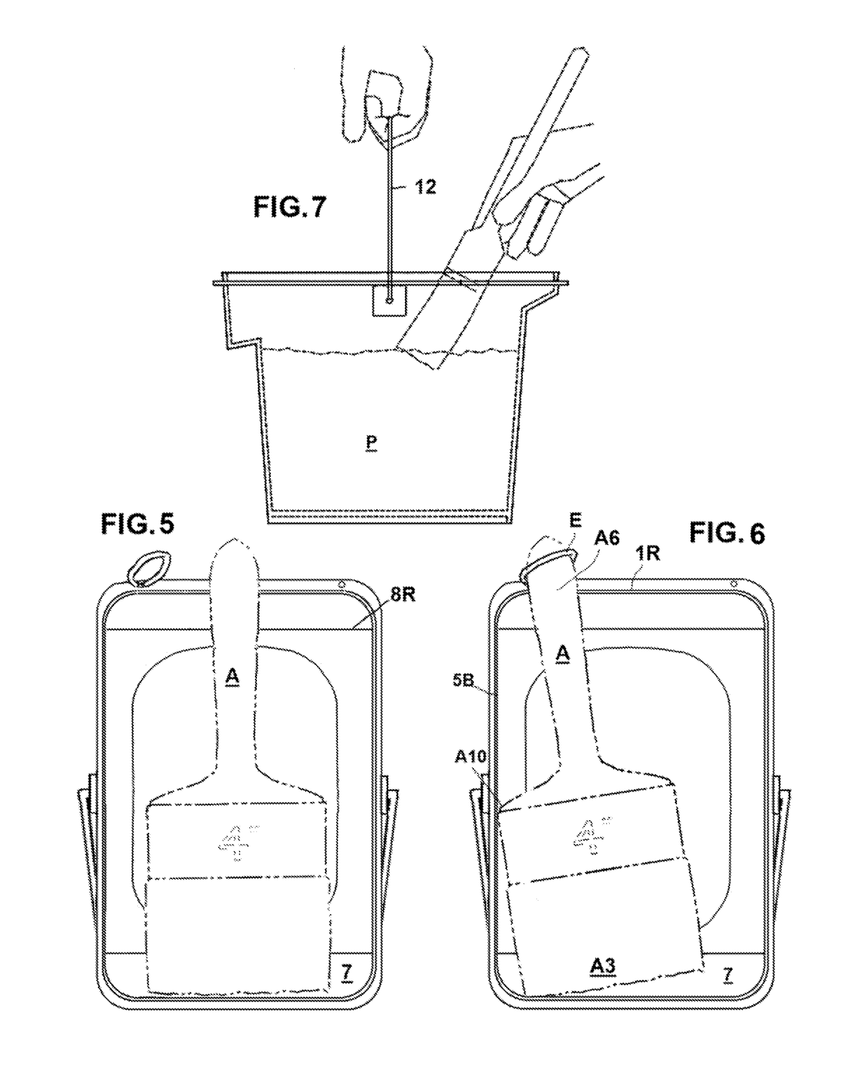

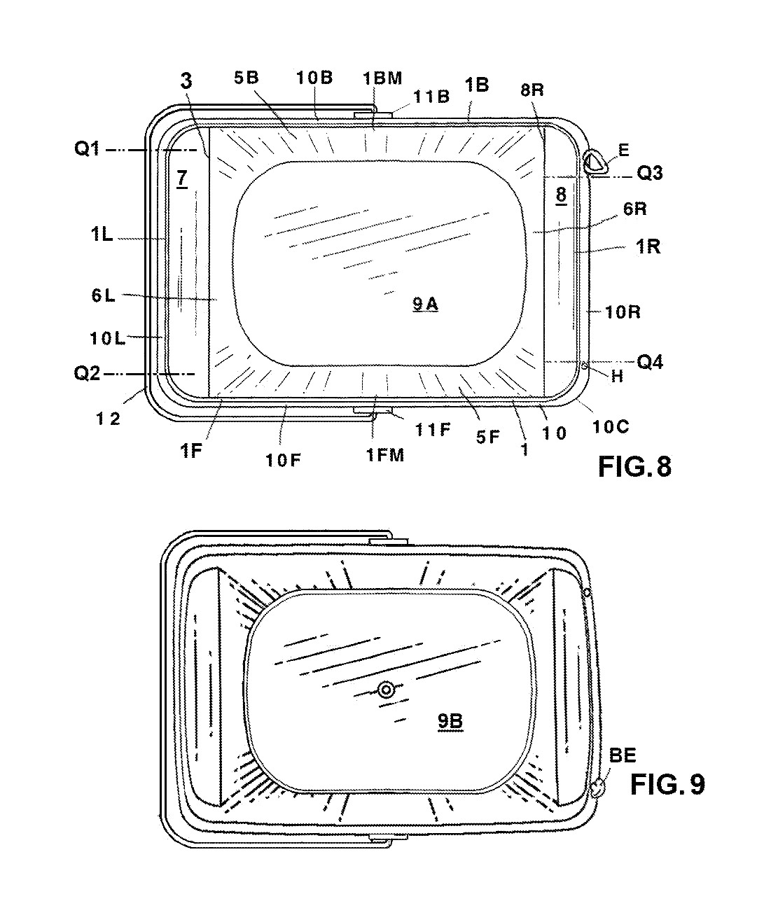

(FIG. 8) The bucket lip is circumferentially continuous and unbroken. for strength and sealing to a lid. The lip has a front lip side 1F, a RHS lip side 1R, a back lip side 1B, and a LHS lip side 1L. Bucket lip is substantially rectangular, substantially wider said LHS lip side to said RHS lip side than from said front lip side to said back lip side. Though said lip is circumferentially continuous, and corners like corner 10C are curved for ease of injection molding and security of lid attachment. The lip is substantially more rectangular than round. The rectangular shape provides for the widest LHS ledge and RHS wiping edge, therein leaving more volume below ledges and wiping edge for paint containment. The bucket is wider LHS to RHS to compensate for the real estate the ledges take up inside the bucket. LHS ledge edge 8L is substantially 2.3″ down from the lip; RHS ledge edge 8R is down about 1″ from the lip. In this embodiment, each ledge protrudes about 1.2″ horizontally centrally into the bucket from a corresponding lip side. The ledges are substantially integrally formed from the buckets narrower side walls (LHS or RHS portions); ledges appearing as substantially horizontally-elongated upside-down L-shaped indentations in the narrower side walls. Ledges can extend 1″ to 1.5″ medially into the bucket, which means a bucket that is 10″ LHS lip side to RHS lip side would have more like 7″ LHS portion to RHS portion below the ledges, minus wall taper. So, below the ledges, the bucket becomes more square or round, making for a substantially-centered bucket bottom for stable support on a surface. The bucket is front-lip-to-back-lip narrow, or not substantially wider than the brush width. (FIG. 5) Like a 6″ front-lip-to-back-lip would allow room for the 4″ wide brush A to be placed on LHS ledge 7 without precision. But narrow enough that a brush handle will not come off bucket RHS lip when brush is angle-laid, and handle cocked frontward or backward. FIG. 6 shows brush handle A6 cocked towards bucket back side 5B. If the bucket were substantially wider front lip side to back lip side, the brush may be able to rotate sideways enough such that either the handle would come off the RHS lip or the bristles would come off of the LHS ledge 7.

Said LHS ledge 7 being substantially flat. Flat ledge being for best paint adhesion between brush and ledge due to paint's high viscosity. The larger the contact surface between wet bristles and ledge, the better the viscous adhesion. Compare a flat ledge to ledge Z1 of Prior Art FIG. 11. Z1 provides a point of support (the edge of the semi-circle), which substantially limits viscous adhesion holding the brush from shifting. A brush in use is always wet with paint when placed on shelf/ledge. (A DRY brush can be placed anywhere without penalty.) The purpose of the shelf/ledge is to keep paint inside the bucket. A brush placed on top of Z1 would be free to move off the tray and onto the floor, as there is no sideways containment for brush bristles (cause try part Z1 can only capture a round roller).

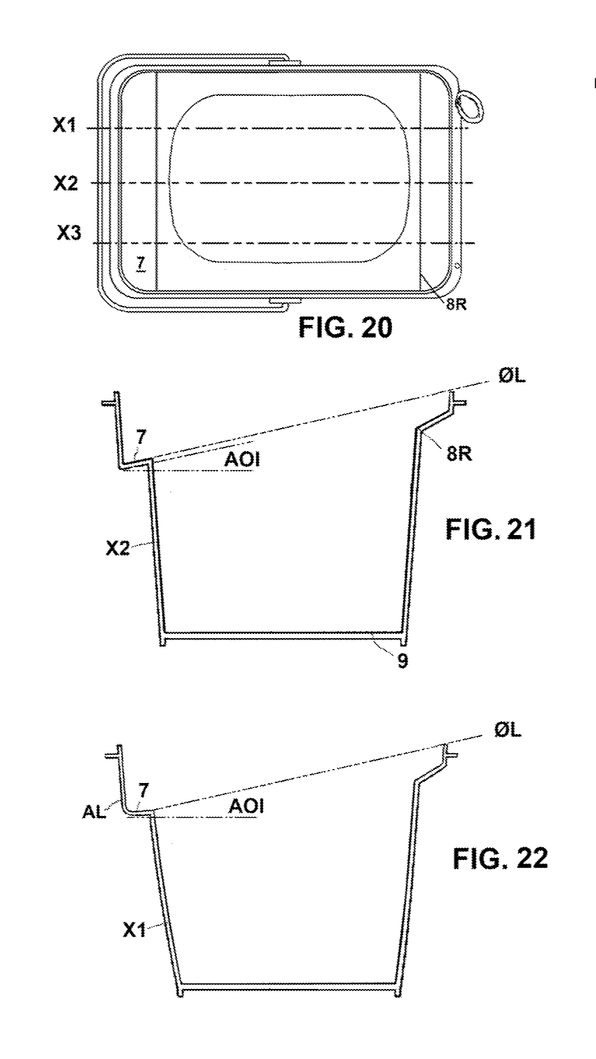

FIG. 20 is the embodiment, top view. X1 is a cross-section, X2 is a cross-section, and X3 is a cross-section. Cross-sections X1 and X3 are substantially similar. FIG. 21 is cross-section X2, front view. LHS ledge 7 LHS ledge inclines medially into said bucket. FIG. 22 is cross-section X1, front view. Said bucket having front side cross-sectional views. LHS above-ledge portion AL and LHS ledge 7 begin to straighten out into each other as LHS portions integrate into bucket back portions. LHS ledge 7's angle-of-incline AOI, shown in both FIG. 21 and FIG. 22, being in a majority of all said front side cross-sectional views. Said LHS ledge being substantially horizontal (i.e. more like the angle of bottom 9 than bucket sides). FIG. 20 is the embodiment, top view, showing lines X1, X2, and X3 for depiction in cross-sectional views FIG. 21 and FIG. 22. Said LHS ledge having an angle-of-incline (AOI in FIGS. 21 and 22); said angle-of-incline AOI inclining medially into said bucket at substantially said angle (angle depicted in FIG. 11 as angle Ø). Said angle-of-incline being in a majority of all said front side cross-sectional views. That is, the angle of incline of the LHS ledge stays consistently at substantially said angle. So LHS ledge being substantially flat.

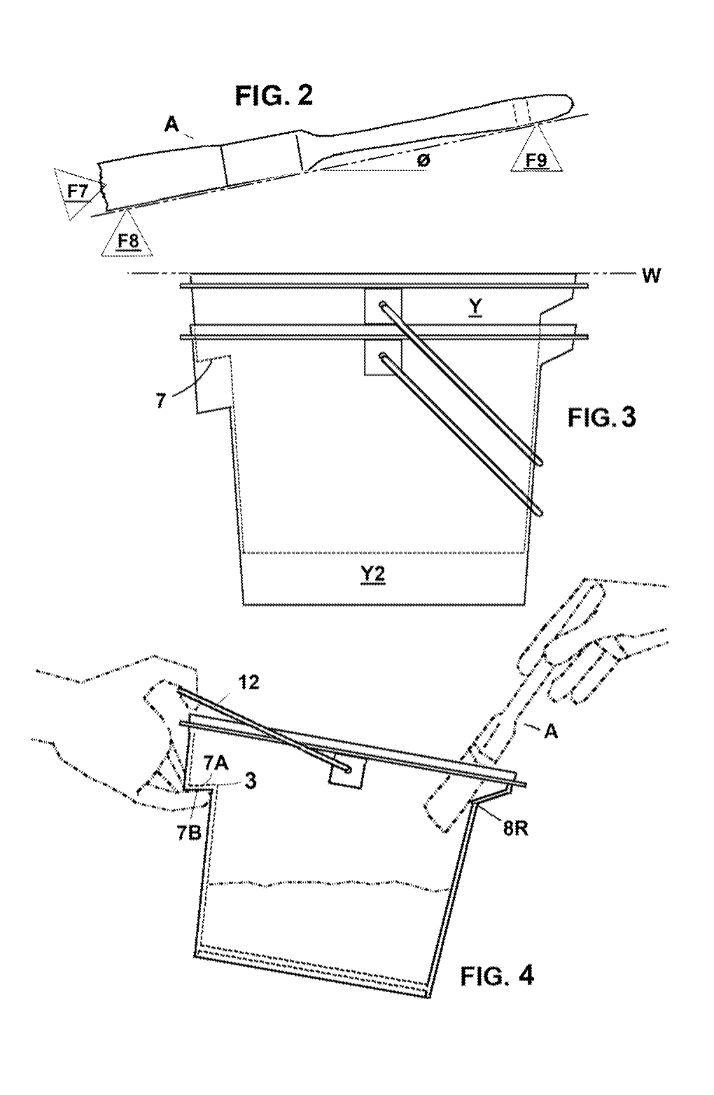

Said bucket having an angle-line øL; said angle line øL substantially being a phantom cross-sectional line at said angle Ø from said LHS ledge to said RHS lip. Said angle-line representing underside of the rectangular brush at said supported angle Ø, cross-sectional view. Angle of support ø being an angle from horizontal: support being substantially more horizontal than vertical. FIG. 2 shows a prior art brush angle-laid, brush narrow side view. Brush A is at the same angle ø as brush A shown in FIG. 1. Wherein support fulcrum F7 depicts the sideways support of LHS above-ledge, fulcrum F8 depicts LHS ledge 7, and fulcrum F9 depicts RHS lip side. In other words, the brush requires distant fulcrums F8 and F9 for upward/vertical support, and requires above-ledge support (depicted as F7) for rightward and upward support. Angle line øL represents the supported flat side of the brush.

A Rectangular brush is substantially straight and rigid when placed at said angle ø with no additional forces acting on it but gravity. Compare invention's brush's angled but substantially horizontal brush support, to a brush supported substantially vertically, like that shown in Combined Strainer and Brush Holder, Sep. 22, 1914, by K. H. Knox. In Knox's FIG. 2, he does not provide handle support, for the angle of support is more vertical than horizontal, so brush handle support is not used/needed.

(FIG. 1) Said bucket having a circumferentially-continuous lip 1M and lip edge 1, said lip edge being the top-most surface of said bucket (in this embodiment, the lip edge is a circumferentially-continuous top edge. Said lip including RHS lip side 1R and LHS lip side 1L. Said LHS lip side and said LHS ledge together of a size and shape that a user can hold said bucket with fingers under said LHS ledge and thumb pressed over said LHS lip side with complete user avoidance of contact with the brush (brush bristle end) when the brush is supported by said bucket in said supporting width. Meaning a user can hold the bucket (fingers under ledge, thumb over rim) while a wet brush is supported on said bucket, and without the user getting paint on their fingers, thumb, or any part of their hand that is supporting said bucket. This overcomes prior art that shows no such means of holding their container, but might be considered ‘graspable’ if only the brush or roller were not in the way. So it overcomes Prior Art FIGS. 11 and 14.

If LHS ledge were perpendicular to said bottom, the user's fingers could dislodge from underneath. It is having an undercut angle that locks plastic housings together, and is needed to grasp a substantially frictionless item, like the undercut underside of LHS ledge. This undercut is more necessary because the bucket weight is weighing the RHS portions of the bucket downward. Without some additional type of friction, a user could not hold the bucket if the ledge were exactly horizontal. Only way a level ledge might be grasped is if the normally smooth outside of the bucket had a very frictional surface on the underside of the ledge. LHS lip is a sharp edge, so a user's thumb actually grabs slightly inside bucket as well, again creating an undercut hold, plus friction hold. The entire outside surface of said LHS ledge is substantially palpable (no handle in the way).

(FIG. 3) said bucket of a size and shape (with 5 degree side wall tapers) such that, when bucket Y is stacked above and with a like-formed bucket Y2, a substantial portion of said bucket Y, including a substantial portion of said above-ledge positions inside like-formed bucket Y2. All of said LHS ledge positions inside like-formed bucket Y2. All said portions of said bucket integrally formed as a single container. FIG. 3 shows two buckets stacked one inside another. Bucket walls are drawn thick in other figures for clarity. Actual wall thickness can average 1-2 mm. The bottom edge of the handle supports rest over the rim of the bucket beneath it, as is the case with many prior art plastic round buckets. The bucket has a downwardly tapered form to be easily removable from a molding tool. A 5° total grade (includes both sides) is average for buckets that stack within each other. The bucket is of a downwardly tapered form to be stackable one said bucket substantially inside an identical bucket.

(FIG. 1) Said RHS portions having a RHS ledge 8, said RHS ledge integrally formed from upper-most parts of said top portions T of said RHS side portions. Said RHS ledge 8 having an interior wiping edge 8R. Said wiping edge positioned inside said bucket. [FIG. 8: Said wiping edge 8R being substantially parallel with said RHS lip 1R]. Said wiping edge positioned substantially in said top portion of said bucket. Said RHS wiping edge being substantially below said angle-line. (So the RHS wiping edge, that gets paint on it when a brush is wiped, will not get paint on the brush handle when the brush is angle-supported.) Said RHS ledge 8 being substantially flat. Substantially flat RHS ledge only flat for simplicity, aesthetics, and to make surface easy to clean. Said RHS ledge extending from said RHS portion medially into said bucket. Embodiment shows RHS ledge beginning/extending medially substantially right under RHS rim portion 10R, so RHS ledge slopes downward medially, helping paint drip back in bucket. But RHS ledge could start at a lower point in top portion T. RHS ledge could also incline medially for unknown advantage. Said RHS wiping edge 8R being substantially straight from bucket front side portions to bucket back side portions. Said wiping edge substantially extending from said bucket front side portions to said bucket back side portions. Said wiping edge having a wiping width. Said wiping width being substantially horizontal. Said wiping width (FIG. 11, Q3 to Q4) substantially at least as wide as width of the rectangular paint brush. (i.e. if bucket is for a 4″ brush, wiping width being at least 4″ wide from Q3 to Q4).

[FIG. 21 Said wiping edge 8R positioning below said angle-line øL.] ØL in FIG. 21 substantially represents the bottom supported side of the brush when the brush is supported (FIG. 1: brush bristle end A3 supported flat side on said LHS ledge 7, brush bristle end A3 abutting against said LHS above-ledge portion AL, and brush handle end A6 supported upwardly on RHS lip side 1R). That means, wiping edge 8L is below said angle line, but still within said top 30% of the bucket. Said RHS wiping edge being substantially below said angle-line øL.

Also, the majority of the volume for paint/fluid containment is below RHS ledge 8. [Compare this to Prior Art FIG. 11, where the majority of the volume for paint/fluid containment is ABOVE Z3.] The bucket sits with stability on flat surface S2 because the planular surface area inside bucket lip is less than twice the surface area of bucket bottom.

### 2. Same Bucket Plus Bucket Handle

(FIG. 8) Said bucket further including a pair of handle supports: front handle support 11F and back side handle support 11B. Said handle supports integrally centrally anteriorly/posteriorly attached to respective bucket front top portion middle 1FM and back top portion middle 1BM. (1FM in said front side portions; 1BM in said back side portions). The supports position slightly beneath/directly beneath the lip at corresponding opposite-side horizontal middles 1FM and 1BM. Attached thereto is prior art wire metal handle, like handle 12. The supports are each of a size and shape to support one of two sides of a prior art style wire handle.

Said bucket having a top view LHS rim profile. LHS rim profile extends from 1BM, leftwardly on the outside edge of back rim portion 10B, downward on the LHS rim portion 10L, then rightwardly on the lowest edge of rim portion 10F.) Handle supports are integrally formed part of said bucket, near the top of the bucket, one located in the left-to-right center of said bucket back portion posterior/wall. [So far, all said portions of said bucket integrally formed as a single container.]

Said bucket further including a handle 12. Handle 12 having (unseen) handle secures. The handle secures are confined to the bucket at front and back midpoints inside said handle supports. Handle secures are rotationally free. Handle is of a size and shape such that the handle can lay against RHS portions of said bucket, be rotated counter clockwise outside said bucket rim, and then be laid against LHS portions of said bucket. The handle is shaped slightly larger than the RHS or LHS rim profile of said bucket.

Handle 12 is shown level with bucket rim 10 in the FIG. 8. The handle secures are confined to the bucket at front and back midpoints inside respective said handle supports. The handle of a size and shape such that the handle can be rotated outside said bucket rim about said handle supports. The handle is shaped slightly larger than said LHS rim profile. The handle and said LHS ledge are together of a size and shape such that a user can hold said bucket, with fingers under LHS ledge 7B, and thumb cupped over said handle 12, like shown in FIG. 4. (FIG. 4) The handle and said LHS ledge together of a size and shape that a user can hold said bucket with fingers under said LHS ledge and thumb cupped over said handle. Again, LHS ledge must be undercut, or else fingers can slip leftward due to bucket weighted with paint.

### 3. Same Bucket Plus Elastic Band

(FIG. 8) Bucket has rim 10 extending substantially horizontally distally from said bucket. Said rim substantially near-top of said bucket. (Rim could be level with lip, or be farther down. In embodiment, rim is about ⅝″ down, but other embodiments it could be perhaps even 1″ down). “Near-top” is substantially in top-most portion of said top portions. Said rim having a RHS rim portion 10R. Said bucket further including an elastic band E, said elastic band confinably attached to said bucket RHS rim portion by extending through hole H in bucket RHS rim portion. The embodiment has two holes (holes, one on back portion of RHS portion (which has elastic band E in it), and one on front portion of RHS portion (which is hole H). (Elastic band E is also noted in FIG. 9).

(FIG. 1) Loop portion EE of said band extending upwardly from said bucket. Said band loop of a size, shape, and elasticity to circumferentially loop over the (brush's) handle end and secure the handle end to said RHS lip side when the brush is supported at said angle (i.e. when the brush is supported upwardly/vertically by said LHS ledge, upwardly by said RHS lip side, and rightwardly by said above-ledge portion). Elastic band E has a bulbous end. The elastic band is squeezably held, near said bulbous end, in said hole. Said elastic band extends through said hole, said loop portion extending upward from said RHS rim portion, and said bulbous end extending below said RHS rim. Said band can also be tightened about a brush handle by a user tightening said loop over the handle of the brush by pulling downward on said bulbous end.

FIG. 26 is a detail of the embodiment holding chip brush, front view. Said rim having a RHS rim portion. Said RHS rim portion having a hole. Said RHS rim portion further including an elastic band. Said band having a loop portion EE. Said band restrainably attached to said RHS rim portion by foceably inserting said loop end through said hole. Said elastic band forceably restrained in said hole. Said loop portion squeezing through said hole and upward from said RHS rim portion. Said band having a bulbous end BE. Said bulbous end extending below said RHS rim. As the chip brush is much shorter, narrower, and lighter than a rectangular paint brush, said elastic band can secure a chip brush inside said bucket as shown. Chip brush is supported upward by two fulcrums: RHS ledge wiping edge 8R, and RHS lip side 1R. The chip brush is frictionally supported upward by said elastic band. Chip brush handle is restrained downward by loop portion EE of said elastic band. Because the chip brush is light in weight, and has a rough-wood handle, said elastic band can frictionally grab chip brush handle end. Band may be secured tighter around brush by pulling down on the bulbous end BE (arrow end) of the elastic band. The elastic band is restrictively held in a small-diameter hole in said RHS rim. Said elastic band confinably attached by said loop portion, near said bulbous end, squeezed in said hole. Having two substantially distant fulcrums (8R and 1R) against the brush keeps the chip brush from bouncing like a teeter-totter when bucket is being moved.

Said bucket having a RHS ledge. Said RHS ledge having a RHS wiping edge. Said RHS wiping edge substantially inside said bucket. Said RHS lip side together with said RHS wiping edge of a size and shape to brace a chip brush flat side against portions of said RHS lip side and said RHS wiping edge when said loop portion is looped over handle of the chip brush and restrainably held down against said RHS lip by said band. That is, restrainably held down by a user sufficiently pulling downward on said bulbous end, to sufficiently hold the chip brush handle against the bucket lip. Said elastic band and said hole of a size, elasticity, and shape that said loop portion can be tightened about the handle of the chip brush by pulling downward on said bulbous end. That is, whatever the thickness or elasticity of the rubber band, or size of the hole, the band is restrainably held in the hole such that force is required to scoot the band upward or downward in the hole. That is, said band can also be tightened about a chip brush handle by a user tightening said loop over the handle of the chip brush by pulling downward on said bulbous end.

The elastic band restrains/holds a chip brush like it holds the rectangular paint brush: at least two substantially-distant fulcrums are needed to support the brush upwardly, and the band contains the brush downwardly, and sideways. It's just that a rectangular brush usually has a smooth handle and substantially more weight to support compared to a chip brush, which is light in weight and has a frictional unpolished wood brush handle.

The bucket extends downward from the bucket lip. RHS rim portion has two holes, one near bucket back side, one near bucket front side portions. Said holes are for confinably attaching a prior art elastic band, like a T-band, wherein the bulbous arrow-head portion of the band positions beneath the hole, and the circular section of the band fits through the hole and substantially positions above the rim. Elastic band is placed towards the bucket's back side in most figures, for a right-handed user's ease of securing a brush handle end. The elastic band could instead be secured to the hole near the front side portions of the RHS rim portion.

### 4. Further Analysis of the Invention

FIG. 4 is the embodiment, user gripping ledge & handle, front view. FIG. 4 is the embodiment with a user gripping under LHS ledge (7B) and handle 12, front view. The user is tilting the bucket and dipping brush A to get the last of the paint, then wiping brush on wiping edge 8R. 7A is the top side of LHS ledge, where the paint brush bristles lay. 7B is the bottom side of LHS ledge. 7B is the surface of contact for user's fingers to hold underneath, supporting bucket. FIG. 5 is the embodiment with a prior art 4″ brush laid flat side on LHS ledge 7, bucket top view. A user can fluidly grab paint brush A by the handle, dip it into the bucket, and wipe it on RHS wiping edge 8R. As bucket is often set on a surface, the adhesive viscosity of the paint on the brush holds it on LHS ledge 7 even with some bucket movement. FIG. 6 is the bucket with same brush A laid flat side on LHS ledge 7, but cocked at front to back angle, bucket top view. When walking with a bucket, a user may wish to secure the brush on LHS ledge 7. Elastic band E's loop portion can be stretched around top portions of brush handle end. Brush A is stabilized, not just by brush bristles laying on ledge 7, but held frontwardly by back portion 5B against brush shoulder A10. Handle end held up by RHS lip, but and handle end secured to bucket rim by elastic band E.

LHS ledge is formed substantially as upside-down L-shaped indentation in the left hand side of the bucket. The RHS & LHS ledges look like upside-down L's when viewed facing said front side portions or said back side portions. LHS ledge substantially positioned near the bottom-most portion of said top portion (near T1) FIG. 7 is the embodiment, user dipping brush & hung from a user's left hand, front view. Ledges above paint containment section P create a wider bucket, which means not having to dip down straight into bucket. When hung from a user's hand, handle 12 is farther away from the buckets rim than a prior art cylindrical can of the same gallon-holding size. The handle (best shown in FIG. 8 as notation 12) is substantially rectangular, like the bucket lip. The handle is longer so it can lay substantially against bucket walls when not in use (handle 12 in FIG. 1). The longer handle adds to the open area for brush dipping. The handle's flat top-portion is more comfortable on the hand to grip than curved handles.

(FIG. 8) The bucket has two opposite side ledges 7 and 8. The ledges each have a substantially straight horizontal edge (edge 7L and 8R) positioned inside the bucket. The ledges each substantially position beneath and substantially parallel with the shorter sides of the lip. FIG. 9 is the embodiment, bottom view. Bulbous portion BE of elastic band noted.

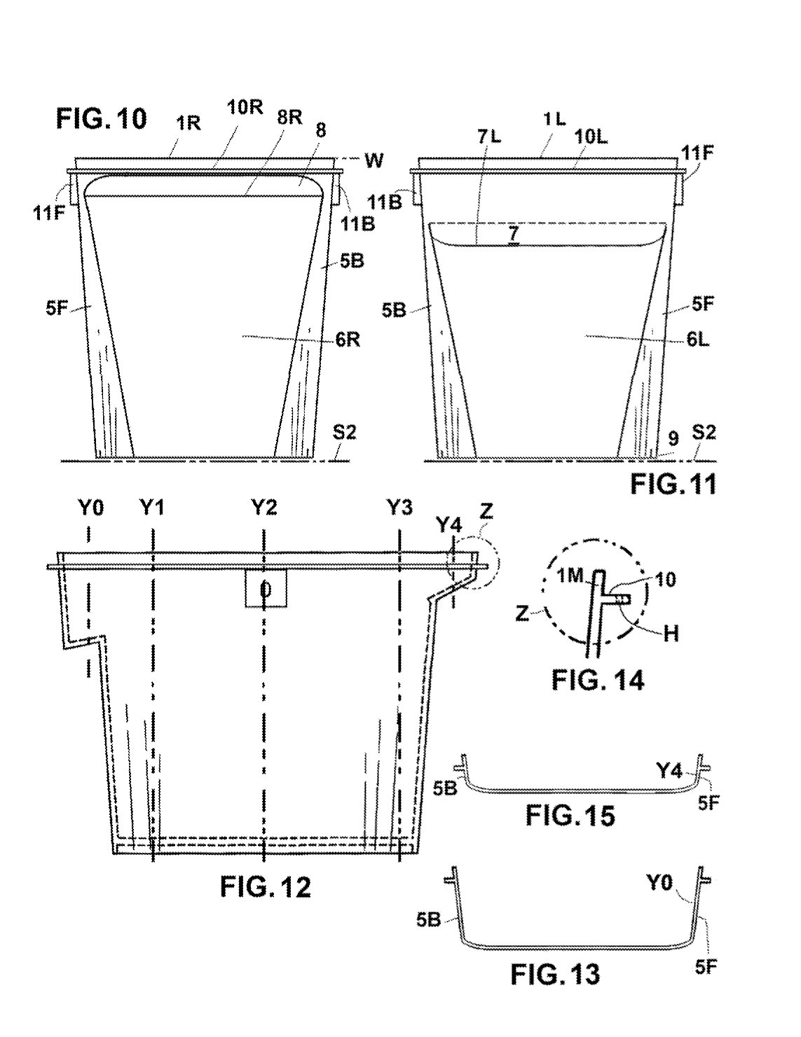

FIG. 10 is the embodiment, RHS view. Handle supports 11F and 11B, right lip side 1R and right rim portion 10R, RHS portions 6R, front side portions 5F and back side portions 5B noted. RHS ledge 8, RHS ledge wiping edge 8R, and surface S2 are noted. FIG. 11 is the embodiment, LHS view. Handle supports 11F and 11B, left lip side 1L, left rim portion 10L, LHS portion 6L, front side portions 5F, back side portions 5B, LHS ledge 7, LHS ledge edge 7L, bottom 9, and surface S2 are noted.

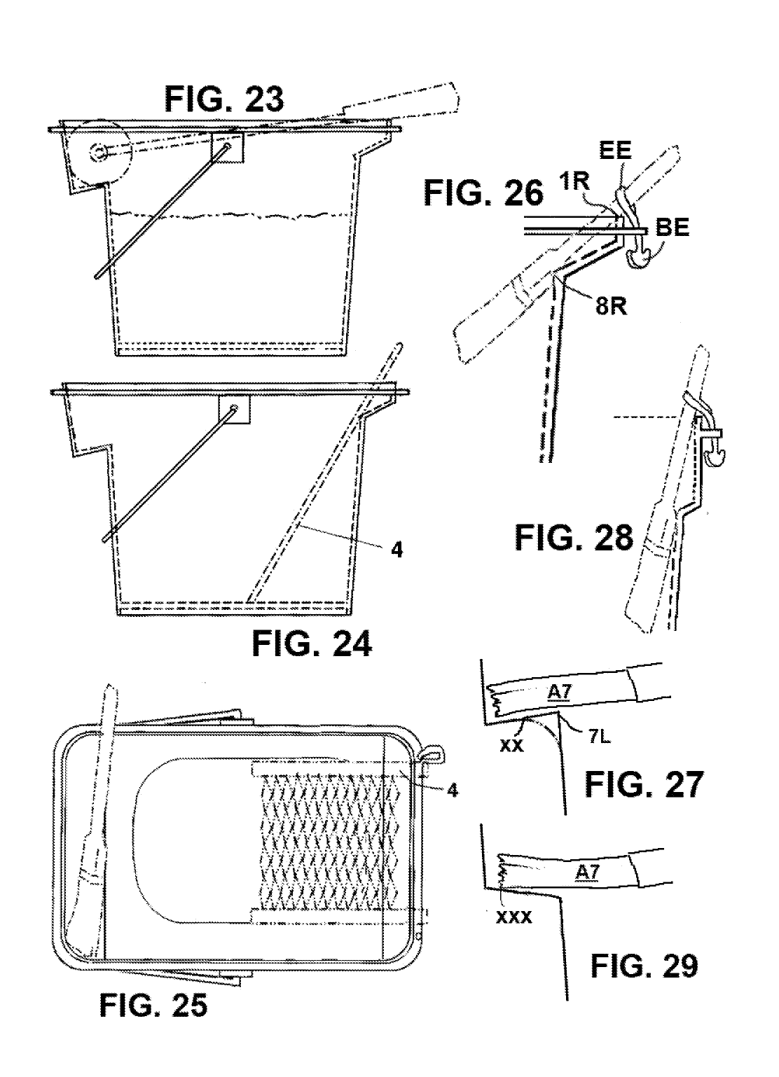

FIG. 23 shows a mini roller (4″ wide, 2″ diameter) positioned laying down on the bucket's LHS ledge and roller handle positioned on (opposite-side) right side lip bucket front view. A 2″ diameter roller might be thought to roll off a 1″ medially-extended LHS ledge but for the 5 degree above-ledge taper, substantially making LHS ledge act like a 1.25″ ledge. That is because the above-ledge contacts the roller 1″ above the LHS ledge. Because of left wall taper above LHS ledge, all wet roller nap stays well inside the bucket. FIG. 24 shows the embodiment, front view with roller grid 4 is shown inside. FIG. 25 is the embodiment with a prior art 4″ roller grid 4, top view. With substantially straight RHS lip side, and straight edge 8R, the grid fits nicely in/on the bucket. Having a grid inside the bucket with paint flowing around it allows a user to roll aggressively up the grid without worries of tipping the bucket (as Sur-Line's bucket molded-in grid might). FIG. 25 also shows a small and short prior art chip brush with bristles on the LHS ledge and handle laying on back lip rim portion. This means of supporting a brush utilizes the front side portions (wall) of the bucket for keeping the brush from moving forward and the back lip rim for supporting the brush handle. The front portion of the ledge is substantially parallel with the back lip rim, therein its utility is substantially similar.

The bucket has circumferentially enclosing side walls: portions 5F, 5B, 6L, and 6R. The bucket has bottom 9 fixedly attached to substantially the bottom edges of all the side walls. The side walls together integrally form circumferentially enclosing side walls. All the side walls have bottom edges. Bottom 9 is fixedly attached substantially to all side wall bottom edges. So together, the bottom and side walls integrally form a container. The bucket substantially is a single molded unit that can contain liquid. Bucket gallon size can be: lip 10″×7″, bottom: 7″×5.5″, & bucket height: 7″.

The depth of LHS ledge is deep enough to keep paint off the left side lip after a brush wet with paint is placed on the LHS ledge (and handle resting on right side lip rim), and to keep the brush slanted in the bucket, to keep it from sliding off, the ledge should be down substantially at least 1″.

The bucket may be injection, vacuum-, blow-, or roto-molded. Or other. Though demonstrated for paint, my buckets utility is of benefit for liquids like wallpaper paste, as well as more viscous materials. In example, a smaller bucket of the same shape could be used for spackle (smaller bucket so spackle knife fits across from the LHS ledge to the opposite-side lip).

The bucket can be used by right or left handed users by just turning the bucket around. Materials to make the invention include, but are not limited to be made from polypropylene, HDPE, or other plastics or resins. The lip is the area near the top of the bucket from the rim down. It may include the top portions of the side walls of a size and shape to mate with a lid. Often the lip can be the top quarter inch of the bucket.

All embodiments show a circumferentially-continuous lip. The LHS ledge is of a size and shape to support bush bristles flat side when brush bristles are placed on the LHS ledge and brush handle is placed on said right rim portion. The RHS ledge wiping edge of a size and shape to wipe a brush flat-side and is for wiping a brush inside said bucket, for keeping paint off the right lip side, and for keeping paint off a brush handle. The LHS ledge is horizontal front-to-back, and slopes upward medially. The RHS ledge is horizontal to sloping downward medially. The distance between upper portion of left side wall and the right side lip is less than the total length of a prior art paint brush, which is most often a distance under 11″.

Though bucket ledge is substantially flat, it could be made rippled, like striped LHS to RHS, such that each front side cross-section would still look straight, and inclining medially. A rippled LHS ledge would create more surface area for contact with a wet brush, as the ripples would let some bristles sink down lower than others.

A rectangular paint brush, for this text, is a paint brush of a 4″ width. Though brush width is not a dimension for claims, the length of 2″ to 4″ brushes, which is substantially consistent no matter what the width, is pertinent to the size of the container, to be available to provide utilities using such brushes. There are many other types of brushes, like chip brushes, art brushes, . . . . Like most inventions, this bucket is constructed to perform with particular items: Human hands, and rectangular paint brushes that average 11″ long. Rectangular paint brushes support more paint than chip brushes, requiring more force to apply, therein a long 11″ handle provides the torque required by a user to apply paint. A short-handled chip brush is shown in FIG. 25, laying on LHS ledge and back lip side.

The bristles are substantially 15 degrees lower in said bucket than said brush handle. Said LHS ledge angling medially upwardly, for matching with said angle of the supported brush, for maximum adhesion to paint-filled bristles, for keeping brush from shifting off said LHS ledge, and for providing undercut surface for a user to securely hold said bucket by grabbing with the user's thumb on LHS of said lip and the user's fingers underneath said LHS ledge.

A container made specifically for a narrower brush, like a 2″ rectangular paint brush, would be made proportionately narrower.

Said bucket having a RHS ledge; said RHS ledge having an internal wiping edge. Said wiping edge being substantially straight. Said wiping edge of a front-to-back width to wipe the entire flat side of a 4″ wide brush. Said wiping edge being on opposite side of bucket from LHS ledge for, when a brush is lifted from angle-sitting in said bucket, said brush can be easily drawn rightwardly to wipe on said RHS wiping edge; said wiping edge is positioned inside bucket, to avoid paint getting on bucket rim; said LHS ledge is positioned inside said bucket to avoid paint on bristles from dripping outside bucket and paint on user's hand when user lifts bucket by way of LHS ledge and LHS lip; said LHS ledge substantially 1.5 times the width of a 4″ brush for ease of placement, yet some front-to-back containment within said bucket.

Said LHS ledge substantially positioned in said top portion such that a majority of said paint containment volume is below said LHS ledge. Said LHS ledge integrally formed portion of said bucket. Said bucket having an integral LHS above-ledge portion above said LHS ledge and below said rim. Said lip being continuously circumferential. Bucket can contain substantially large volume of paint: 12 cups below LHS ledge and substantially one gallon of paint slightly above said LHS ledge but below RHS wiping edge. Such that, if bucket is filled with 1 gallon of paint, the brush can be angle-laid on the ledge and only have the brush bristles inside the paint volume. So LHS ledge is high enough up to keep the rest of the brush parts (like the ferrule and handle) out of the paint. So said LHS ledge provides its utility even when paint in the container is above the LHS ledge!!

Said RHS wiping edge protruding substantially less than ⅙ of the way medially into said bucket. LHS ledge less than ⅕ medially into said bucket. Measures are from bucket lip dimensions, and are not exact measures. Said bucket for large open dipping area and for containment of substantially a gallon of paint.

Bucket invention substantially restrains a brush wet with paint on LHS ledge; distance between RHS and LHS being short enough that handle end can rest on RHS lip. LHS ledge tilting upward medially for supporting brush in tilted/angled position. A user can hook-grab under ledge and on top of bucket lip to carry bucket while brush is supported in said angled position on said bucket. Invention is substantially a rectangular-lipped paint bucket, with opposite-side, substantially parallel-edged ledges, ledges formed from the circumferentially-continuous walls. Said ledges substantially beneath the bucket's opposite-side narrower lip sides. The RHS ledge is substantially 1/7 down from said lip into the bucket, tilting medially downward slightly into bucket. The LHS ledge is substantially ⅓ down into the bucket from the bucket lip and tilting medially upwardly into bucket.

These RHS and LHS ledges are formed substantially as upside-down L-shaped indentations in the bucket's narrower sides. Each ledge edge protrudes substantially 1″ into the bucket, and is substantially 6″ wide. The RHS ledge is for brush wiping below the bucket lip. The LHS ledge, along with the bucket lip rim on the opposite side, is for brush support. The LHS ledge doubles as a handle. The purpose of having the brush angle-supported in the bucket stabilizes the brush in the bucket against bucket movement, and keeps paint on the brush off the lip. (With a user's right hand) a brush can be easily grabbed from being supported at said angle, drawn rightwardly off said LHS ledge, and wiped on said RHS wiping edge, all with ease.

### 5. Conclusion

The invention provides a LHS ledge for supporting a brush bristle end, an above portion for supporting and rightwardly containing the brush in the bucket. It provides a RHS ledge for brush wiping, and a rectangular rim, therein enlarged, area for brush dipping. When a brush is placed horizontally, or at a substantial horizontal angle, elastic band securing the handle is one way to keep the brush from dislodging itself off the bristle supporting shelf.

The bucket can be a one-piece moldable from a 2-part tool with slides. Buckets can be closely stacked, for saving shipping and shelf space. L-shaped ledges allow buckets to be easily made and closely stacked. This invention is an injection-moldable, substantially rectangular lipped paint bucket, with opposite-side, substantially parallel-edged ledges, ledges formed from the walls beneath the rectangles opposite-side narrower sides. In one embodiment, the RHS ledge is substantially 1″ down from the bucket lip. The LHS ledge is substantially 2″ down from the bucket lip. These ledges are formed substantially as upside-down L-shaped indentations in the bucket's narrower sides. Each ledge edge protrudes substantially 1″ into the bucket, and is substantially 6″ wide. The RHS ledge is for brush wiping below the bucket lip. The LHS ledge, along with the bucket lip rim on the opposite side, is for brush support. The LHS ledge doubles as a handle.

Said bucket having a bottom; said bottom having substantially the equivalent surface area of bottom of a prior art cylindrical gallon paint can, for stability when said bucket is set on a flat surface.

Distance front to back side of bucket top portion is confining enough that, if brush so placed, brush handle can shift frontward and backward on bucket without dislodging bristles off LHS ledge or dislodging handle off RHS lip. Flat LHS ledge angles medially upwardly, to mate/adhere to the angled supported brush bristles, and for user to support bucket, grabbing under ledge and over rim.

### 6. Improved Description

“Lateral” identifies sideways. Lateral side is a RHS or LHS of the bucket. “Anterior” identifies front;” posterior” identifies back, “distal” identifies away from point of attachment or origin. “Bristle end” is any part neck down on a brush. FIG. 10 shows RHS rim portion 10R. FIG. 11 shows LHS rim portion 10L. Therein, both 10R and 10L are lateral rim portions. The description of “bottom side” of LHS ledge (under side) is also the external surface of that LHS ledge. LHS and RHS ledges are substantial L-shaped indentations in the otherwise substantially straight LHS and RHS (lateral) sides of the bucket.

The ledges each have a substantially straight horizontal edge. Such an edge is substantially a horizontal line, transitioning from the ledge to the substantially vertical lateral same-side of the bucket. Each edge is substantially in a single horizontal plane, parallel to the lip edge of the bucket; parallel to the bottom of the bucket. This allows the LHS ledge to support brush bristles evenly, so the brush does not slide to the side of the bucket (like if the edge were not horizontal). This allows the wiping edge to be substantially evenly spaced from the bucket lip, so wiping keeps paint off the lip. Each edge substantially parallel to the lateral sides of the bucket, and if there are two ledges, each with their own edge, the two edges are parallel to each other.

The ledges are substantially perpendicular to the front and back sides of the bucket (substantially, because the front and back sides of the bucket often can have a 4% taper from vertical to ease molding release.) The reason the edges need to be perpendicular to front and back sides of the bucket, and why the edges are parallel to the lateral sides of the bucket, are to allow balanced ledge support of a brush.

FIG. 12 is a view indicating cross sections. FIG. 12 shows cross-sections Y0, Y1, Y2, Y3 and Y4, drawn as phantom lines. FIG. 15 is a bucket cross section and shows cross-section Y4, LHS view. Front bucket wall 5F and back bucket wall 5B are noted. FIG. 13 is a bucket cross section and shows cross-section Y0, LHS view. Front bucket wall 5F and back bucket wall 5B are noted. The exterior surface of the bucket substantially follows the internal surface of the bucket. FIG. 12 indicates detail Z. FIG. 14 is a cross section detail of FIG. 12, and is detail Z. FIG. 14 shows rim 10, hole H, and lip 1M. Hole H is a vertical hole. But for the hole, this lip and rim profile is substantially identical circumferentially around the bucket, exception being rim can extend more horizontally/distally (like on RHS of bucket) to provide enough selvage/rim distally so the hole H (and band placed in the hole) will stick out beyond a lid that mates to the lip.

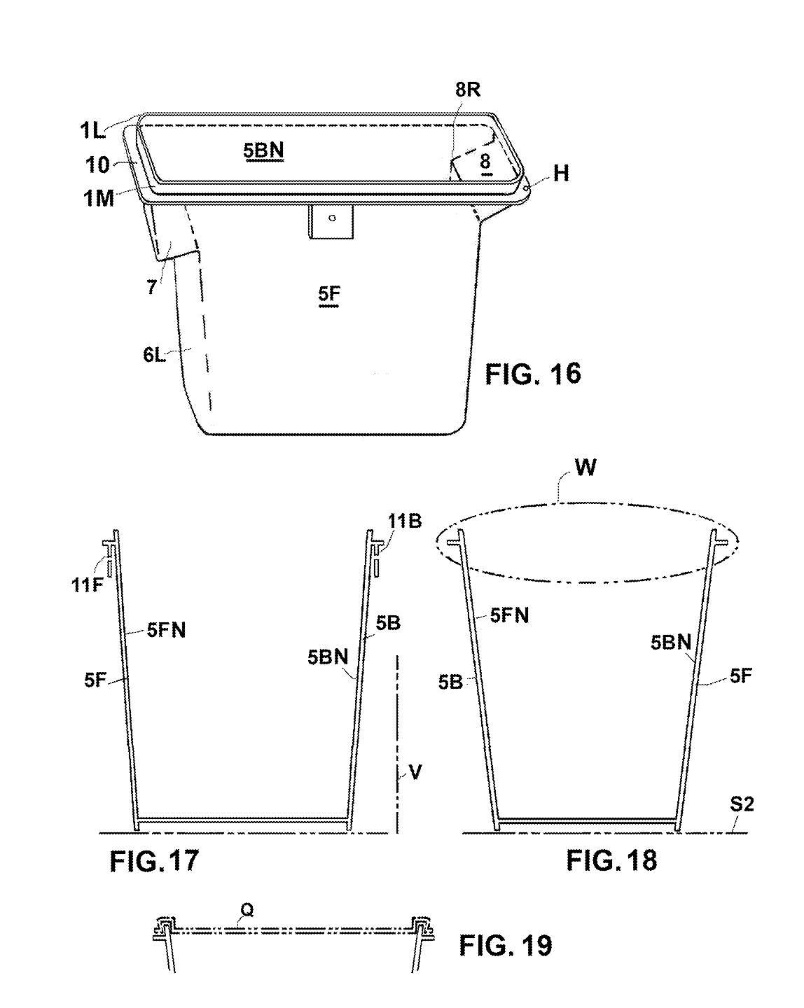

FIG. 16 is the bucket, front perspective view. (Bucket bottom hidden lines not detailed). Inside surface of back side 5BN, RHS ledge 8, front hole H, front side 5F, LHS 6L, and LHS ledge 7 are noted. Perhaps this perspective view makes clearer that the interior surface of back side (and similarly front interior side) are continuously vertically straight. It shows rim 10 is circumferentially continuous (continuous for bucket strength), and horizontally wide. It shows lip 1M is vertically tall and circumferentially continuous. It shows lip edge is continuous and unbroken. That is, lip is a circumferentally-continuous closed band as the top of the bucket The bucket is shown in all drawings and is described as an injectable molded bucket. That is, it is integrally molded: The lip, the rim, the ledge(s), the hole(s) formed in the bucket rim, all are one fixedly attached integrally molded unit. Such is needed to have a bucket that, at the very least, will not leak, and can be sealed with a lid.

FIG. 17, a bucket cross-section, shows cross-section Y2, LHS view. Front bucket wall 5F and back bucket wall 5B are noted. Interior surface of front and back bucket wall are noted as 5FN and 5BN respectively. The interior surfaces 5FN and 5BN are substantially vertically straight. Even with 4% taper, wall is still substantially straight in the vertical direction V. The exterior surface of bucket walls 5F and 5B include handle supports 11F and 11B. Other than at handle supports, the exterior surface of the bucket substantially follows the internal surface of the bucket.

FIG. 18 shows cross-section Y1, LHS view. This cross section is substantially identical to cross section Y3, so only Y1 is drawn. Front bucket wall 5F and back bucket wall 5B are noted. Interior surface of front and back bucket wall are noted as 5FN and 5BN respectively. The interior surfaces 5FN and 5BN are substantially vertically straight. And continuously substantially vertically straight, even as LHS and RHS walls attach to front and back walls, The exterior surface of the bucket substantially follows the internal surface of the bucket. Interior front and back sides being continuously vertically straight allows for maximum container space for paint.

FIG. 18 also shows W a rim cross section area of FIG. 18 cross-section.

FIG. 19 is a bucket cross section detail of FIG. 18 (area W) plus prior art style lid Q. Lid is substantially flat horizontally, with a 360 degree continuous circumferential upside-down U shaped channel. The U shaped channel is for sealing against a prior-art style bucket with a 360 degree continuous vertical lip rim. Such a prior art style lid uses the horizontal distal pressure of the horizontally flat lid portion to press the U channel's inside medial surface against the internal side of the bucket's lip rim, providing the watertight seal between the bucket and lid. The peripheral/distal side of the inside of the lid's U-shaped channel grips to the external side of the bucket's lip rim, to keep the lid from lifting up off the lip. This is a PRIOR ART method of sealing a bucket, and is almost universal on all 5 gal plastic buckets of paint. This seal is secured by the circumferentially continuous (360° around) bucket lip forced against a circumferentally continuous (360° around) lid rim.

Consider if a bucket lip rim were NOT circumferentially continuous for the full 360 degrees, in a single horizontal plane. In example, if one tried to seal Armstrong's container, the lid could no longer be made horizontal at Armstrong's notch. Which means the horizontal distal pressure could not hold against the lower area of the notch. Such is the reason why all paint buckets, designed to mate with a lid, have continuous lip rims, where every portion/for 360 degrees around the bucket, the top of the lip rim is in one horizontal plane at the top of the bucket. Note Wolff's cleaning bucket does not have its lip in a single horizontal plane. It dips down on RHS and LHS to allow for pouring of liquid. Which is a reasonable trade-off for allowing a locking lid, as no one needs a lid on a cleaning bucket.

It is essential that front and back sides of the bucket be substantially continuously vertically straight such that maximum front-to-back distance of the bucket remains as wide as possible for 4″ wide-brush dipping to the bottom of the bucket. Front-to-back narrowness needed at bucket top to restrain a 4″ brush from shifting off a wider ledge. That is, if the brush handle was restrained by the band, the bristle end still has front-to-back rotational movement about the band axis. If the bucket was much deeper front-to-back, the bristles might rotate off the LHS ledge. That is, if the bucket had a much greater front-to-back distance, to accommodate a ledge-like feature on front and back bucket sides, the distance from the front to the back of the LHS ledge would have to be made wider by the width of any front plus back side ledge. The front to back distance needs to be essentially not much wider than a 4″ brush, otherwise, brush could slide sideways and dislodge from a position supporting bristles of LHS ledge. Narrower brushes don't have this issue because the weight of the bristle end, even if brush rotates, does not dislodge part of the brush off the ledge. Front and back sides must be substantially straight to maximize volume of the bucket below RHS and LHS ledges. In the invention, RHS and LHS ledges reduce the width of the bucket by over 25%. If front and back sides had ledges, or any additional intrusion, there would be limited width to dip a wide brush. There would be substantially reduced volume of the bucket. As a brush length-tip to handle end—is short, ANY reduction in width of the container would reduce the amount of paint that can be contained.

FIG. 3 shows horizontal plane W. FIG. 10 also shows the same horizontal plane W. The top of the bucket lip is the top-most surface of the bucket, and the top-most portion of the lip portion. The bucket's lip portion has continuously identical circumferential profile. Lip top edge is circumferentially continuous, 360 degrees around the top horizontal plane of the bucket lip portion. Lip is the bucket portion above the rim that provides a continuous vertical male I-shaped cross-sectional profile to mate with the upside-down U shaped channel of a lid, like a prior art lid. The vertical male I cross-sectional profile is also prior art. The circumferentially continuous lip is substantially a vertically-tall band that is a horizontally circumferentially continuous closed loop; similar in shape to the shape of a common rubber band. Lip portion needs to have continuously identical circumferential profile to mate with a lid. In example, Wolff's cleaning bucket has a notch to lock a bucket handle. Wolff does not have a vertical male I, lip cross-section, but rather an upside-down U shape. So the internal side of Wolff's lip does not have substantially follow the profile of his lip internal surface. So claims exclude Wolff-style lip by writing ‘the exterior surface of the lip has substantially the profile of said lip internal surface. That is, the profile of any cross-section of the lip is I-shaped.

Bucket rim extends distally all 360 degrees around the outside of the bucket. That is, rim is circumferentially continuous and unbroken around the bucket. The rim extends distally around the entire bucket to prevent the lip and lip rim from substantial flexing, Rim extending distally around the entire bucket is prior art. Some buckets, like 5 gallon buckets, use multiple rims, one below the next. Where some containers not used for paint can have minor ledges, like Wolff, which are used to add bucket strength, a paint container uses straight side walls so the least amount of internal obstructions allows the thicker-than water paint to not dry on the internal walls.

FIG. 1, FIG. 21, and FIG. 22 show the exterior surfaces of both LHS and RHS ledges substantially follow the profile of the interior surfaces of those ledges. The exterior surfaces of those ledges are also the exterior surfaces of the bucket at the ledge. The exterior surface of either ledge being the bucket exterior surface at that ledge. That is, an even thickness of plastic forms the RHS and LHS ledges, as that same even thickness of plastic forms the front and back sides of the bucket.

FIG. 4 shows ledge LHS internal edge 3 and RHS ledge edge (wiping edge) 8R. [FIG. 4 also shows LHS internal edge 3.] The transition from the lateral ledges is sharp for several purposes: The edge of the LHS is the main straight line of support for brush bristles; If the LHS ledge CURVED into the bucket, the TOP of that curve would become the first line of contact with brush bristles. This is demonstrated in FIG. 27, which shows brush support of LHS ledge. Brush bristles A7 sit on LHS ledge, LHS ledge edge 7L notated. The weight of the bristle end is supported substantially on edge 7L. If LHS ledge had a curved, versus sharp-edge transition into the bucket's lower LHS, the main support line would be at location XX. Result of a curve versus edge substantially reduces the lateral support of the bristles, where the bristles, which are substantially flexible, could easily slip into the bucket. (This is the same reason the transition from LHS bucket wall ABOVE ledge to LHS ledge is also sharp, as curving there also reduces lateral support of he brush bristles). If the ledge were made laterally wider, to compensate for the ledge curving into the bucket, the paint-containing area would be reduced (as the distance from LHS to RHS can't be greater, or else a brush could not support from RHS rim to LHS ledge).

If the RHS ledge curved into the bucket, instead of having a sharp edge, it would no longer be adequate to wipe a brush, which is why Bird uses a straight rod. The more the RHS ledge curves into the bucket below, the more the area for containing paint is reduced, or the closer RHS ledge must be to RHS lip, which is what the RHS wiping edge is trying to avoid getting paint on.

FIGS. 1, 4, 7, 12, 13, 14, 15, 17, 18, 21, 22, 23, and 24 all show the exterior surfaces of the bucket substantially follow the interior surfaces of the bucket, excluding the rim, handle supports, and bucket bottom. That is, the bucket has substantially the same wall thickness throughout. Throughout, ALL portions of the bucket have the same wall thickness. Consistent wall thickness throughout is needed to produce injection molded parts without voids.

Where FIG. 26 shows an example of a bristle-end-supporting ledge edge. The brush is 45 degrees from vertical, which is a substantial horizontal angle. Such angle is measured from the inside lip edge, where the brush handle is supported against the bucket, to the point where the RHS ledge edge contacts the brush neck (or ferrule, depending on type of brush). At such an angle, a substantial portion of the weight of the brush is supported by the RHS ledge edge. The brush end, filled with paint, is the heavier end. Any angle much less than 45 degrees, minus whatever friction between brush handle and band, would allow the brush to slip out of the band and into the bucket. Similarly, when a brush handle is held by the band, and bristles position on LHS ledge edge, the brush is supported at an angle much greater than 45 degrees from vertical. Such that a substantial portion of the weight of the brush is supported by the ledge edge. FIG. 28 shows example of NON-supporting ledge edge. If a same-side-as-band ledge does not protrude far enough into the bucket, the ledge provides virtually no horizontal support. As a brush handle is smooth, with little bulbousness to catch if the brush slips down, a non-supporting ledge edge.

### 7. Analyzing Claims

Independent claim: “A paint and brush support system” because it includes both the integrally molded bucket, plus a squeezably attached band, plus later a rotationally attached handle. Bucket containing paint and brush can be carried by LHS bucket ledge and lip, by LHS ledge and handle, and by brush handle secured with band. So claim is for a system.

“said system including a bucket, said bucket being integrally molded;” This is to guarantee understanding that the lip, the rim, the sides, and the ledges are integrally formed parts of the bucket.
Claim further states, “said bucket having a lip; said lip being a circumferentially-continuous closed band as the top of said bucket” a closed band excludes any remote extrapolation of the notched out top of Armstrong.

“said lip being vertically tall; said lip being substantially vertically straight; said lip having a top edge” This is a prior art feature: a tall thin band about the bucket top that allows a prior art style lid, with a female channel to lock onto this bucket lip. “as the top of said bucket” meaning the lip is an integrally molded part of the bucket. Fixedly attached.

“exterior surface of said lip substantially following the profile of said lip internal surface” clarifies that the lip does not have further parts. That is, the lip member is continuous and unobstructed. In example, Wolff has a vertical lip portion, PLUS a flat top portion, plus an exterior downward-facing portion, so the lip's profile is substantially an upside down U shape, and the exterior surface of the lip does not follow the lip's internal surface, because the inside of Wolff's lip U shape is OUTSIDE the bucket, and is no longer an interior surface.
“said lip top edge all being in same horizontal plane” also clarifies both that there are no dips in the lip for pouring spouts, and that the lip is of equal height to secure a prior-art style lid.
“said lip having an internal surface; said lip having an external surface; said exterior surface of said lip substantially following the profile of said internal surface of said lip” clarifies that lip is not upside-down U shaped.

“said bucket having top portion; said top portion having a rim; said rim below said lip;” It is important that the rim is below the lip, so rim does not interfere with lid attachment. “said rim extending distally 360 degrees horizontally around said top portion; said rim being horizontally/distally wide”. This describes the rib or ribbing buckets use to strengthen the container. This ribbing is also used to strengthen invention container.

“said bucket having a front side and a back side; said front side and back side being substantially continuously internally vertically straight” this describes most prior art paint buckets, where all sides (square or round in shape) have internally vertical walls.

All the above bucket identification is common prior art for a paint bucket, and identifies most 5 gal plastic bucket containers and many reusable plastic food containers.

“said bucket having at least one ledge on a lateral side, extending, from same lateral side, medially into said bucket; said ledge being an indentation in the top third of said bucket; said ledge being below said lip” The value of the ledge(s) is to keep paint off the lip.

“said ledge internal surface having an internal edge; said ledge having a ledge exterior surface” This passage describes either a RHS ledge or a LHS ledge. Armstrong has a ledge and straight side walls, but does not have a continuous closed band lip and does not have a rim. “an internal edge” specifies the ledge is not a rolling indentation into the bucket, like bucket-strengthening rolling side indentations 360° around the bucket, like Wolffs, and not rolling indentations.

“said ledge exterior surface substantially following the profile of said ledge internal surface; said ledge exterior surface being the bucket exterior surface at said ledge;” That is, the exterior side of a ledge substantially follows the internal side of the ledge. This passage also describes either a RHS ledge or a LHS ledge. Armstrong's exterior profile at his ledge is a handle, so passage does not describe Armstrong's ledge. That is, bucket is single-wall construction, where ledges are formed by wall indentations, not additional parts.

Armstrong's ledge does not meet claim in rim, continuous lip, and bucket profile under ledge. Storage containers do not meet vertically straight front and back sides and at least one ledge on a lateral side.

“said rim having a RHS lateral rim portion; said rim having a LHS lateral rim portion” This passage clarifies that either RHS or LHS is a lateral side.

“said RHS rim portion having at least one vertical hole.” states both rim hole, and lateral side of rim hole. Stating RHS rim portion sets up for ease of describing dependent claims. Frantz has at least one vertical hole, but does not have a 360 degree substantially wide rim, and does not have a ledge as an indentation in top third of container.

“said ledge internal edge being substantially horizontal; said ledge internal edge being substantially perpendicular to said front side and said back side; said ledge internal edge being the medial-most edge of said ledge;” Even though the ledge is described as being an indentation in a lateral side of a bucket, this set of passages clarifies that the ledge edge is horizontal, that the edge is perpendicular to front and back side, and locates the edge as the medial-most part of the ledge, before the bucket transitions downward.

(passages not in same order as claim)

Dependent claim 2 “said system further including an elastic band” Adding an elastic band would be more multiple references. “said band having a loop end and a bulbous end; said band and said hole of a size and shape such that said loop end can be forceably inserted into and secured in said hole, loop end facing upward.” This clarifies the type of band (loop plus bulbous end), and identifies method of attachment between bucket and band not presented by or extrapolated from prior art.

“said lip having a RHS lip side at said lip top edge;” stated to be sure it is clear in next passage that the band tightens the brush handle against the RHS side of the lip, and handle tightens, not against inside or outside of the lip, but against the top edge.
“said loop end forceably inserted into and secured in said hole, loop end facing upward, and handle end of a paint brush is inserted in said loop”, which says ban IS inserted into hole as described in claim 2. “said bulbous end can be pulled downward to tighten the brush handle against said RHS lip side;” which further describes the size of the band, and starts to describe how brush is held. “wherein, when said loop is tightened about the handle end against said RHS lip side, and bristle end of the brush positions inside said bucket” describes where the brush is located for utility.
(out of order) “a substantial portion of the weight of the brush supported on a said internal ledge edge.” This is to prevent confusion that the band holds the brush entirely against the lip edge. That is an unsecured teeter-totter hold. Most of the brush weight is at the bristle end.
“the bristle end of the brush can be supported at a substantial horizontal angle by the bristle end” The bristle end supported at a substantial horizontal angle prevents any confusion that the brush may be held vertically by a ledge, with bristle ends on the ledge. Full description is that the brush is held by two fulcrums: the lip edge and ledge edge. As described, the bristle end could be supported by a LHS edge or RHS edge. As the ledges have to be indentations in a lateral side of the bucket, and front and back have NO indentations (vertically straight), and all bucket parts are one molded item, any removable shelf does not meet description. As well as lateral ledge exterior side is described as the exterior surface of the bucket.

Dependent claim 3 states, “wherein said at least one ledge being a LHS ledge.” This is to describe the LHS ledge (where a larger brush rests its bristles) is opposite the RHS rim side where the band holds the brush handle end.

BECAUSE LHS ledge is opposite RHS lip edge, the only way brush bristles can be supported on LHS edge is if the ledge declines laterally distally/towards LHS. That is, the decline is moving away from the bucket center in the lateral direction. If LHS ledge INCLINED, the brush could no longer be supported by LHS ledge edge. Such is demonstrated in FIG. 29, demonstration of a non-functional LHS ledge, where ledge edge is LOWER than the rest of the ledge, or rather the ledge declines medially. Brush bristles A7 would then rest on the medially-declining, (distally inclining) ledge at location XXX, and the brush would slowly slip into the bucket.

Dependent claim 4 states, “wherein said LHS ledge declining laterally distally at substantially the angle of the brush supported on said LHS ledge edge.” The edge of the LHS ledge is the substantial support of the brush. Having the ledge at an angle substantially matching the angle of the supported brush also holds/supports the brush, including by adhesion. That is, the paint adheres to the brush, and similarly adheres to the ledge, so long as the ledge is at a similar angle.

“and said ledge internal edge being a LHS ledge edge.” just makes it easier to read that the edge and ledge are of one ledge.
Dependent claim 5 states, “wherein said bucket further including a RHS ledge” i.e. a second ledge, opposite lateral side of LHS ledge.
   “said RHS ledge extending, from RHS of said bucket, medially into said bucket; said LHS ledge being an indentation in the top third of said bucket; said RHS ledge being below said lip; said RHS ledge having a RHS ledge internal surface; said RHS ledge internal surface having a RHS ledge internal edge; said RHS ledge internal edge being substantially horizontal; said RHS ledge edge being substantially perpendicular to said front side and said back side; said RHS ledge having a RHS ledge exterior surface; said RHS ledge exterior surface substantially following the profile of said RHS ledge internal surface; and, said RHS ledge exterior surface being the bucket exterior surface at said RHS ledge. “This claim 4 virtually states that the second ledge has all the characteristics of the (first) ledge: having an internal edge, but RHS ledge is on same side as the rim hole(s) band.
   Dependent claim 5 states, “wherein said LHS ledge declining laterally distally at substantially the angle of the brush supported on said LHS ledge edge” repeats claim 4, “said RHS ledge inclining laterally distally” describes the RHS ledge/wiping ledge, which inclines as it moves laterally distally.

Dependent claim 6 states claim 4, plus, “and, said RHS ledge inclining laterally distally.” RHS ledge inclines as ledge moves towards the (RHS) lateral side, and inclines as the ledge moves away from the RHS edge. Same as LHS ledge declines as the ledge moves away from LHS edge.

Claims 7-11 were already allowed by Examiner, so are not further analyzed.

I claim:

1. A paint and brush support system, said system including a bucket, said bucket being integrally molded; said bucket having a lip; said lip being a circumferentially-continuous closed band as the top of said bucket; said lip being vertically tall; said lip being substantially vertically straight; said lip having a top edge, said lip top edge all being in same horizontal plane; said lip having an internal surface; said lip having an external surface; said exterior surface of said lip substantially following the profile of said internal surface of said lip;
said bucket having top portion; said top portion having a rim; said rim below said lip; said rim extending distally 360 degrees horizontally around said top portion; said rim being horizontally/distally wide;
said bucket having a front side; said front side being substantially continuously internally vertically straight; said bucket having a back side; said back side being substantially continuously internally vertically straight;
said bucket having a RHS lateral side; said bucket having a LHS lateral side; said bucket having at least one ledge on a lateral side, extending, from same lateral side, medially into said bucket; said ledge being an indentation in the top third of said bucket; said ledge being below said lip; said ledge having a ledge internal surface; said ledge internal surface having a ledge internal edge; said ledge internal edge being substantially horizontal; said ledge internal edge being substantially perpendicular to said front side and said back side; said ledge internal edge being the medial-most edge of said ledge;
said ledge having a ledge exterior surface; said ledge exterior surface substantially following the profile of said ledge internal surface; said ledge exterior surface being the bucket exterior surface at said ledge;
said rim having a RHS lateral rim portion; said rim having a LHS lateral rim portion; and,
said RHS rim portion having at least one vertical hole.

2. The paint and brush support system of claim 1;
said system further including an elastic band; said band having a loop end and a bulbous end; said band and said hole of a size and shape such that said loop end can be forceably inserted into and secured in said hole, loop end facing upward;
said loop end forceably inserted into and secured in said hole, loop end facing upward;
said lip having a RHS lip side;
wherein, when handle end of a paint brush is inserted in said loop, said bulbous end can be pulled downward to tighten the brush handle against said RHS lip side at said lip top edge; and
wherein, when said loop is tightened about the handle end against said RHS lip side, and bristle end of the brush positions inside said bucket, the bristle end of the brush can be supported at a substantial horizontal angle by the bristle end, and a substantial portion of the weight of the brush supported on a said internal ledge edge.

3. The paint and brush support system of claim 2;
wherein said at least one ledge being a LHS ledge; and said ledge internal edge being a LHS ledge edge.

4. The paint and brush support system of claim 3; wherein said LHS ledge declining
laterally distally at substantially the angle of the brush supported on said LHS ledge edge.

5. The paint and brush support system of claim 3;
wherein said bucket further including a RHS ledge,
said RHS ledge extending, from RHS of said bucket, medially into said bucket; said RHS ledge being an indentation in the top third of said bucket; said RHS ledge being below said lip; said RHS ledge having a RHS ledge internal surface; said RHS ledge internal surface having a RHS ledge internal edge; said RHS ledge internal edge being substantially horizontal; said RHS ledge edge being substantially perpendicular to said front side and said back side; said ledge internal edge being the medial-most edge of said ledge; said RHS ledge having a RHS ledge exterior surface; said RHS ledge exterior surface substantially following the profile of said RHS ledge internal surface; and,
said RHS ledge exterior surface being the bucket exterior surface at said RHS ledge.

6. The paint and brush support system of claim 5; wherein said LHS ledge declining laterally distally at substantially the angle of the brush supported on said LHS ledge edge; and, said RHS ledge inclining laterally distally.

7. A paint bucket, said bucket substantially having front side portions,
back side portions, RHS portions, LHS portions, and a bottom, together integrally forming said bucket: said bucket having volume for containing liquid; said bucket having a circumferential lip; said lip being the top surface of said bucket; said bucket having a height; said height being from said bottom to said lip;
said bucket having a top portion, said top portion being substantially the top 30% of said height;
said LHS portions having a LHS ledge; said LHS ledge integrally formed from lower-most parts of said top portions of said LHS side portions;
said LHS portions including a LHS above-ledge portion, said LHS above-ledge portion extending above said LHS ledge; said lip having a RHS lip side;
said bottom being substantially horizontal;
said bucket having a LHS-to-RHS supporting length, said supporting length substantially being from said LHS above-ledge portion, substantially at said LHS ledge, to said RHS lip side; said supporting length being of a length to support a rectangular paint brush at an angle: brush bristle end supported flat side on said LHS ledge, brush bristle end abutting against said LHS above-ledge portion, and brush handle end supported on RHS lip side;
said angle being an angle from said horizontal; said LHS ledge having a shelf width; said shelf width substantially extending from said front side portions to said back side portions; said shelf width substantially at least as wide as width of the rectangular paint brush; majority of said volume for containing liquid being below said LHS ledge; said LHS ledge being substantially flat; said bucket having front side cross-sectional views; said LHS ledge having an angle-of-incline; said angle-of-incline inclining medially into said bucket; said angle-of-incline being substantially said angle; said angle-of-incline being in a majority of all said front side cross-sectional views;
said lip having a front lip side, a back lip side, said RHS lip side, and a LHS lip side; said lip being circumferentially continuous;
said bucket lip being substantially rectangular, said lip being substantially wider said LHS lip side to said RHS lip side than from said front lip side to said back lip side; and
said LHS lip side and said LHS ledge together of a size and shape that a user can hold and support said bucket with fingers under said LHS ledge and thumb pressed over said LHS lip side, with complete user avoidance of contact with the rectangular brush bristle end when the rectangular brush is supported by said bucket in said supporting length;
wherein said bucket of a size and shape
such that, when said bucket is stacked above and with a like-formed bucket, a substantial portion of said bucket, including all of said LHS ledge, positions inside the like-formed bucket
wherein said bucket having an angle
line; said angle line substantially being a phantom line from said LHS ledge, at said angle, to said RHS lip side; said RHS portions having a RHS ledge, said RHS ledge integrally formed in said top portions; said RHS ledge having a wiping edge; said wiping edge being substantially straight; said wiping edge positioned inside said bucket; said wiping edge being substantially below said angle-line; said wiping edge being substantially within said top portion; said wiping edge substantially extending from said front side portions to said back side portions; said wiping edge being substantially horizontal; said wiping edge having a wiping width; said wiping width substantially at least as wide as the width of the rectangular paint brush; and majority of said volume for containing liquid being below said RHS edge;
wherein said bucket having a circumferential rim; said rim being near-top of said bucket; said rim extending substantially horizontally laterally from said top portion; said rim having a RHS rim portion; said bucket further including an elastic band, said elastic band confinably attached to said RHS rim portion, said elastic band having a loop portion; said loop portion extending upwardly from said RHS rim portion; said loop portion of a size, shape, and elasticity to circumferentially loop over the brush handle end and secure the brush handle end to said RHS lip side when the brush is supported at said angle: brush bristle end supported flat side on said LHS ledge, brush bristle end abutting against said LHS above-ledge portion, and brush handle end supported upwardly on RHS lip side.

8. The paint bucket of claim 7, wherein said RHS rim portion
having a hole; said elastic band confinably attached to said RHS rim portion by extending through said hole; said elastic band having a loop portion; said elastic band having a bulbous end; said elastic band squeezably held in said hole; and said loop portion extending upward from said RHS rim portion, and said bulbous end extending below said RHS rim portion, wherein a user can tighten said loop over the handle of the brush by pulling downward on said bulbous end.

9. The paint bucket of claim 7, wherein said elastic band having a loop portion; said elastic band having a bulbous end; said elastic band squeezably held in said hole; and said loop portion extending upward from said RHS rim portion, and said bulbous end extending below said RHS rim portion, wherein a user can tighten said loop over the handle of the brush by pulling downward on said bulbous end.

10. The paint bucket of claim 7, further including a pair of handle supports; said front side portions having a front top portion middle; said backside portions having a back top portion middle; said handle supports integrally laterally attached to respective front top portion middle and back top portion middle; said bucket further including a handle; said handle having handle secures; such that, when the handle secures are confined to the bucket at front and back midpoints inside said handle supports; the handle secures being rotationally free; said bucket having a top view LHS rim profile; said handle of a size and shape such that said handle can be rotated outside said bucket rim about said handle supports; the handle being shaped slightly larger than said LHS rim profile; and said handle and said LHS ledge of a size and shape together such that a user can hold and support said bucket, with fingers under said angle-of-incline of said LHS ledge, and thumb cupped over said handle.

11. The paint bucket of claim 7, wherein said band restrainably attached to said RHS rim portion by foceably inserting said loop end through said hole.
